(19) United States
(12) Patent Application Publication
(10) Pub. No.: US 2008/0191607 A1
(43) Pub. Date: Aug. 14, 2008

(54) Phosphor, Method For Producing Same, And Light-Emitting Device Using Same

(75) Inventors: Chihiro Kawai, Hyogo (JP); Ryuichi Inoue, Hyogo (JP)

Correspondence Address: GLOBAL IP COUNSELORS, LLP, 1233 20TH STREET, NW, SUITE 700, WASHINGTON, DC, 20036-2680, US

(73) Assignee: Sumitomo Electric Industries, Ltd., Osaka-shi, Osaka (JP)

(21) Appl. No.: 11/661,686

(22) PCT Filed: Aug. 25, 2005
(86) PCT No.: PCT/JP05/15470

§ 371 Date: Aug. 14, 2007

(30) Foreign Application Priority Data
Sep. 3, 2004 (JP) 2004-256433
Sep. 3, 2004 (JP) 2004-256434
Sep. 7, 2004 (JP) 2004-259438
Jan. 26, 2005 (JP) 2005-017676
Jan. 26, 2005 (JP) 2005-018124

(51) Int. Cl. H01J 1/62; C09K 11/54

(52) U.S. Cl. 313/503; 252/301.6 R

(57) ABSTRACT

A Phosphor represented by the general formula Zn₍₁₋ₓ₎AₓS:E,D is characterized by having a Blue-Cu light-emitting function. In the above general formula, A represents at least one group 2A element selected from the group consisting of Be, Mg, Ca, Sr and Ba; E represents an activator containing Cu or Ag; D represents a coactivator containing at least one element selected from group 3B and group 7B elements; and x represents a mixed crystal ratio satisfying 0≦x<1. The activator is preferably contained at a molar concentration equal to or higher than that of the coactivator for obtaining emission of short wavelength. As the activator, Cu and Ag are respectively used by themselves, while Ag can be suitably used in combination with Au.

### FIELD OF THE INVENTION

The present invention relates to a light-emitting material, and particularly to a phosphor that emits light in the UV region. The present invention more particularly relates to a phosphor that is suitable for a light-emitting device as means for separating or decomposing toxic substances and sterilizing bacteria, viruses, and the like. The present invention also relates to a phosphor that uses a light-emitting device for emitting UV rays by inorganic electroluminescence (EL) to emit light, and to a method for manufacturing the phosphor. The present invention also relates to a fluorescent lamp as a light-emitting device and to a field-emission display that uses the fluorescent lamp. The present invention furthermore relates to a surface-emitting device having a surface-emitter that emits visible light rays or UV rays by inorganic EL to emit light, or excites a phosphor by the emitted visible light rays or UV rays to emit light.

### BACKGROUND OF THE INVENTION

Due to environmental problems in recent years, there is a strong demand for a function that separates or decomposes toxic substances and sterilizes bacteria, viruses, and the like. Photocatalytic materials are receiving attention as means for carrying out such decomposition and sterilization. A typical photocatalyst is TiO₂, and this photocatalyst demonstrates a photocatalytic function by using UV rays that generally have a wavelength of 400 nm or less. Anatase TiO₂ demonstrates a photocatalytic function based on the use of UV rays that have a wavelength of 400 nm or less. Rutile TiO₂ that functions up to a wavelength of about 420 nm has also recently been developed, although the function of this substance does not match that of anatase TiO₂.

Mercury lamps and light-emitting diodes are also devices that emit light having such wavelengths, but since these are point or linear light sources, they are not suitable for uniformly exciting photocatalysts that have a large surface area. An inorganic EL device is also a device that uniformly emits light over a large surface area. This device is one in which a phosphor powder dielectric resin that functions to emit light is dispersed in a dielectric resin, and AC electric field is primarily applied to cause light to be emitted. In addition, a phosphor that very efficiently emits UV rays is required as a light source for exciting the photocatalyst as well as for insect trapping, UV exposure, resin curing, and other applications.

A ZnS phosphor is an example of a phosphor that emits light with high efficiency. Among ZnS phosphors, those that emit light at a short frequency are commonly activated using Ag, but the emission wavelength corresponds to that of 450-nm blue light, and the phosphors can emit light only in the visible light region. This light-emitting mechanism entails a process in which the Ag activator added to the ZnS forms an acceptor level; the Cl, Al, or the like added as a co-activator form a donor level; and electrons and positive holes are recombined between the donor level and the acceptor level, whereby a D-A pair type (also referred to as Green-Cu type, and will be referred to hereinafter as “G-Cu type”) blue light having a peak wavelength of about 450 nm is emitted. In this G-Cu type emission, the wavelength can be reduced by increasing the bandgap of the phosphor matrix, wherein the phosphor matrix is a mixed crystal composed of ZnS and a compound having a bandgap that is greater than that of ZnS. A sulfide of a Group 2A element is an example of a compound that can increase the bandgap in a mixed crystal combination with ZnS. However, the wavelength can be reduced only to the violet region in which the peak wavelength exceeds 400 nm, even in a Zn_{0.8}Mg_{0.2}S:Ag-based phosphor in which MgS is solidified to its solidification limit with respect to ZnS. In this case, the tail end on the short-wavelength side of the emission spectrum is 400 nm or less, and the ZnS:Ag phosphor does not emit electroluminescent light through the application of an electric field.

Japanese Laid-open Patent Application No. 2002-231151 describes a process in which the emission efficiency and chromaticity are improved by simultaneously adding a Cu or Ag activator to the phosphor matrix, which is a mixed crystal semiconductor composed of ZnS and a sulfide of a Group 2A element, and a co-activator having a molar concentration that is equal or greater than that of the Cu or Ag activator. However, it is described in this prior art that light emissions other than the main light emissions of a G-Cu type do not exist in its emission spectrum, and that the emission wavelength is in the visible light region.

Due to environmental problems in recent years, the use of devices and apparatuses that use mercury as a light-emitting body has come to be restricted. Typical devices that use mercury include fluorescent lamps; low-, medium-, high-pressure, and extra-high-pressure mercury lamps; and other illumination or light source devices. All of these operate under the principle of causing visible light or UV rays to be emitted by irradiating the phosphor using UV rays generated by electric discharge from the mercury.

In contrast, fluorescent display tubes and other fluorescent lamps are used as light-emitting devices that do not use mercury and that are environmentally friendly. These lamps emit visible light by irradiating phosphors using an electron beam generated from a hot cathode or a cold cathode; have features that include long life, high reliability, and low power consumption; and are used as onboard displays and outdoor display devices (Japanese Laid-Open Patent Application Publication No. 2001-176433).

The most standard fluorescent lamp has phosphors deposited (patterned) on the anode (plate) of a directly heated triode, and uses a grid to control thermoelectrons emitted from a filament. The phosphors emit light when the thermoelectrons strike the anode. The filament material is fundamentally a tungsten alloy, but various other alloys are also used.

Recently LCDs (Liquid Crystal Displays), organic EL displays, and the like have come to be used, and these displays remain slightly better than fluorescent display tubes overall because of their wide viewing angle, good quality light emission, long life, improved operating temperature range, and other features, and are primarily used in audio and video equipment because of their particularly good quality light emission and clear display. The displays are also used in automobile clocks and the like because of their good visibility and reliability. Organic EL displays also have strong points in that the viewing angle is wide and the emission efficiency is high because of the self-luminescent feature. However, there is drawback in that the longevity of these displays is short. On this point, the longevity of fluorescent lamps exceeds 30,000 hours. The longevity of fluorescent display tubes can be further extended and the reliability increased because the undesirable burning-out of the heat filament can be overcome by using a cold cathode.

Nevertheless, conventional fluorescent display tubes are used solely in display device applications, and are not therefore used to emit UV rays. In fluorescent display tubes, a method has been proposed in which phosphors that are caused to emit UV light by irradiation with an electron beam are coated on the surface of a phosphor powder that are caused to emit visible light by irradiation with an electron beam. This is based on the principle that UV rays are initially generated by directing an electron beam on a UV-emitting phosphor, and then generating visible light having the desired wavelength by directing the generated UV rays onto a visible light-emitting phosphor. Reported examples of an UV-emitting phosphor include ZnO and ZnO.Ga₂O₃:Cd (Japanese Laid-open Patent Application Nos. 8-127769 and 8-45438).

Also developed in recent years as another application of phosphors is a phosphor that continues to emit light for a fixed period of time after a power source system of a building has been cut off when a disaster or the like has occurred (Japanese Patent No. 2543825). This application is one in which the energy of visible light or UV rays is directed for a prescribed period of time or longer onto phosphors, whereby the energy is stored by the phosphors, and the stored energy is continuously emitted as light when power is cut off. A surface emitter manufactured by forming such phosphors into sheets is combined with a common fluorescent lamp or the like in indoor applications, and is designed to use the energy of sunlight rather than an artificial light source in outdoor applications to continue emitting light after sundown.

### SUMMARY OF THE INVENTION

Emission of a G-Cu type blue light in a ZnS phosphor reaches only into the violet region and light is not emitted in the UV light region even if the bandgap of the ZnS is increased and the emission wavelengths are reduced. Also, a Cu— or Ag-activated ZnS phosphor is believed to produce an emission that is referred to as Blue-Cu (hereinafter referred to as “B-Cu”) on the short-wavelength side of G-Cu emission when Cu or Ag enters not only the Zn position of the crystal lattice, but also interstitial positions. When Ag is used as an activator, however, the ion radius of Ag is greater than the ion radius of Zn (0.133 nm for Ag vs. 0.083 nm for Zn), and entry into the crystal interstices is difficult even if the Zn position in ZnS is occupied. Therefore, B-Cu emissions cannot be easily obtained. EL emissions do not occur in such as case.

When the activator is Cu, on the other hand, the ion diameter of Cu is less than that of Ag and is substantially the same as that of Zn ions, and there is therefore an advantage in that interstitial entry can be facilitated. Although EL emission does occur in this case, the energy level of the activator Cu is deeper than that of Ag, for which reason it has so far been impossible to reduce the B-Cu emission wavelength to a peak wavelength of about 450 nm, and the tail end on the short wavelength side is as yet greater than 400 nm. In other words, there are no emission components in the violet region of 400 nm or less.

Therefore, in order to solve the problems described above, an object of the present invention is to provide a phosphor that produces B-Cu emissions and to provide a method for manufacturing the phosphor when an activator comprising Ag or Cu is used in a ZnS-based phosphor. Another object of the present invention is to provide a phosphor in which EL UV emissions having a short wavelength occur when Cu is used as an activator, and to provide a method for manufacturing the phosphor. Yet another object of the present invention is to provide a phosphor that generates B-Cu emissions having not only G-Cu bluish purple emissions, but also an emission peak in the UV region on the short wavelength side of the G-Cu bluish purple emissions. This object is achieved by crystallizing ZnS together with another sulfide, finely adjusting the amount of Ag or other activators and co-activators, and finely adjusting the method for mixing the starting materials, the baking conditions, and making other adjustments, so that Ag entry into the interstices is facilitated when Ag is used as an activator. Another object of the present invention is to provide a phosphor in which interstitial doping of Ag ions can be stabilized to allow short-wavelength light to be emitted when an activator comprising Ag is used, and in which an electroconductive phase required for EL emissions can be formed along crystal grain boundaries, twin boundaries, and dislocations.

For a fluorescent display tube, an invention in which the aforementioned phosphor that is caused to emit UV light by irradiation with an electron beam is applied on the surface of a phosphor powder that is caused to emit visible light by irradiation with an electron beam is designed to obtain a fluorescent display tube that emits visible light rather than to obtain a device for emitting UV rays. The reason for this is believed to be as follows. A phosphor that can produce UV rays with good efficiency via electron beam irradiation has not previously existed. In such a fluorescent display tube, a phosphor that emits visible light absorbs UV rays emitted by a phosphor that emits UV light, and visible light is emitted. At the same time, the fluorescent display tube itself absorbs the electron beam to a certain extent and emits visible light. The intensity of the UV rays is therefore not required to be very high. However, when only a UV-emitting phosphor is used, the emission efficiency is too low and the UV-emitting phosphor cannot be used as a fluorescent lamp that emits UV light.

The present invention can solve such problems as well, and another object of the present invention is to provide a fluorescent lamp in which the phosphor of the present invention is used, which is based on the principles of fluorescent lamps or fluorescent display tubes, and which has a simple structure, is very bright overall, and can be used as a long-life UV light source.

For a surface phosphor in which the above-described persistent phosphor is worked into the form of a sheet, a light source is required for the sheet in indoor applications, and the device therefore becomes bulky since a fluorescent lamp, for example, is required. In particular, UV rays with considerable energy are required to excite the persistent phosphor with good efficiency in a short period of time, and since the amount of UV rays in the fluorescent lamp is very low, irradiation must occur over a long period of time and power consumption is increased. When a black light or another UV lamp is used in place of the fluorescent lamp, irradiation time can be kept short, but the problem of bulkiness remains. In particular, bulkiness is a critical issue when a thin profile is required for backlight or other component of a mobile phone and a personal computer.

On the other hand, a thin EL sheet is used in backlights for mobile phones and clocks. The fundamental feature of such a sheet, however, is that the backlight lights up to display a screen when the user operates the device, but the sheet goes off after several tens of seconds after operation has ended, and the screen is difficult to view in dark locations. The relight button must therefore be pressed to light up the backlight in order to view the clock or other information in dark locations.

Therefore, a further object of the present invention is to provide a surface-emitting device that uses the phosphor of the present invention, has low power consumption that can excite the phosphors in a short period of time, and uses a surface emitter that is not bulky.

The present invention for achieving the above-described objects is described below.

### 1 Phosphor of the Present Invention

In accordance with the present invention, a phosphor is provided that is characterized in having a function to emit blue-Cu light and in being expressed by the general formula Zn₍₁₋ₓ₎AₓS:E, D, wherein A is at least one type of Group 2A element selected from the group consisting of Be, Mg, Ca, Sr, and Ba; E is an activator comprising Cu or Ag; D is a co-activator comprising at least one element selected from a Group 3B element and a Group 7B element; and x is a mixed crystal ratio that satisfies the expression 0≦x<1. The phosphor of the present invention has a B-Cu light-emitting function and is manufactured so that a mixed crystal ZnS-based material is used in which the phosphor matrix is mixed with MgS, CaS, or another Group 2A sulfide that has a large bandgap, Cu or Ag is included as an activator (acceptor), and Cl, Al, or another short-period Group 3B or Group 7B element of the periodic table of the elements is added as a co-activator (donor).

A phosphor having a function for emitting B-Cu light can be produced by adding an activator containing Cu or Ag in a molar concentration that is equal to or greater than the molar concentration of the co-activator. In the present invention, the content of Cu or Ag, which is not charge compensated, is increased and the interstitial entry of an activator containing a larger quantity of Cu or Ag is facilitated by a method in which an activator containing Cu or Ag is added to the ZnS-based phosphor in a molar concentration that is greater than the molar concentration of the co-activator.

A co-activator having a molar concentration that is equal to or greater than the molar concentration of the Ag activator is added to obtain the ZnS-based phosphor described in Japanese Laid-open Patent Application No. 2002-231151. Since the co-activator added to the ZnS-based phosphor also acts to compensate the charge of the activator, it is possible that all of the Ag activator in the ZnS-based phosphor described in Japanese Laid-open Patent Application No. 2002-231151 is charge compensated. Charge-compensated Ag is substituted in the Zn position in the crystal lattice and does not enter the interstices. Therefore, the emission exhibited by the phosphor described in Japanese Laid-open Patent Application No. 2002-231151 is not a B-Cu type emission, but is solely a G-Cu type emission.

When UV rays are directed onto a phosphor (PL), a G-Cu emission generally appears at the same time that a B-Cu emissions appears, and when an electron beam (CL) or an electric field (EL) is applied, the relative intensity of the B-Cu emission is further increased and the emission spectrogram often develops a shape in which the long-wavelength side is extended.

The B-Cu emission is described below. A ZnS:Cu, Cl phosphor generally has the doped Cu substituted in the Zn position, and the Cl simultaneously substituted in the S position. The emission wavelength demonstrates a green color in the vicinity of 530 nm, which is referred to as a G-Cu emission. On the other hand, when Cu is substituted in the Zn position and is simultaneously introduced into the gaps in the ZnS crystal lattice, a light emission occurs that is referred to as a B-Cu emission having a short wavelength in the vicinity of 460 nm. These two emissions occur at the same time, and therefore two peaks appear in the emission spectrum. The photoluminescent (PL) spectrum obtained when the phosphor is excited using UV rays generally has a peak intensity that is highest on the long-wavelength side, but a cathode luminescent (CL) spectrum or an electroluminescent (EL) spectrum obtained when the excitation is produced using an electron beam or an electric field has a peak intensity that is highest on the short-wavelength side, or a clear peak sometimes does not appear at all on the long-wavelength side. The same phenomenon occurs when Ag doping is used instead of Cu doping, and the emission of light on the short-wavelength side is referred to as a B-Cu emission, similar to the case in which Cu is used.

In the present phosphor, the peak wavelength of the emission spectrum can be controlled by varying the value of the mixed crystal ratio x. The peak of the emission wavelength shifts toward the short-wavelength side as the value of x increases. In this case, the peak wavelength of the emissions is preferably kept in a range of 360 to 375 nm. This wavelength band is the most often used wavelength for curing UV-curing resins.

The following means, for example, can used to determine whether the emission spectrum contains a B-Cu emission. If, for example, the phosphor matrix is ZnS—MgS, the bandgap of the matrix can be calculated as long as the concentration ratio of Mg to Zn is known. The wavelength of the emission peak produced when DA pair light or B-Cu light is generated can be calculated from the energy level of the activators and co-activators as long as the activator and co-activator elements doped in the phosphor are known. A method therefore exists in which the determination can be made by drawing a comparison with the actual wavelength. Also, the concentrations of the activator and co-activator can be measured, and if the former is greater than the latter, it can be deduced that the spectrum contains a B-Cu emission. Also, the position occupied by the activator element can be determined by XAFS analysis in which strong X-rays are used. G-Cu and B-Cu emissions can therefore be differentiated.

In the phosphor of the present invention, a mixed crystal composed of ZnS and at least one Group 2A element selected from BeS, MgS, CaS, SrS, and BaS is used as the phosphor matrix, whereby the crystal lattice can be more easily expanded and a larger amount of a Cu— or Ag-containing activator can be allowed to enter the interstices more easily. In the case of MgS, for example, the solid solubility limit of MgS expands about 0.05 nm in the a-axis direction and about 0.04 nm in the c-axis direction. A B-Cu emission produced by the Cu— or Ag-containing activator that has entered the interstices can be more easily obtained and the bandgap of the phosphor matrix can be increased by using a mixed crystal composed of ZnS and a Group 2A element as the matrix. There are therefore advantages in that the wavelength of a B-Cu emission is further shortened, and an emission having a shorter wavelength in the UV region can be obtained.

This phosphor can be used in CL applications and PL applications that produce emissions in the UV region, and can also be used in EL applications by combining Cu₂S or another Cu—S-based compound as the electroconductive phase, and carbon nanotubes or another electrically conductive substance. There are also expectations that a light-emitting element obtained using PL, CL, and EL based on the present invention can be used as a UV-emitting source.

### 2 Method for Manufacturing the Phosphor of the Present Invention

In the method for manufacturing the phosphor according to the present invention, a Group 2A sulfide powder and a ZnS powder, which are starting materials for the phosphor matrix; a starting material powder for an activator (a prescribed amount of Ag₂S powder in the case of Ag); and a starting material powder for a co-activator (e.g., a prescribed amount of pulverulent Al₂S₃, Ga₂S₃, NaF, NaCl, NaBr, or NaI as at least one type of starting material selected from Al, Ga, F, Cl, Br, and I) are dispersed in ethanol, and ultrasonic vibrations are then applied to mix the components. The ethanol containing the starting materials is dried using an evaporator in which dry nitrogen or dry argon is caused to flow in order to prevent hydrolysis or oxidation of the Group 2A sulfide. The recovered dry starting materials are placed in a lidded alumina or quartz crucible; baked for 2 hours at 1,000° C. in hydrogen sulfide gas, hydrogen gas, argon gas, or nitrogen gas; and then subjected to cooling and annealing treatments to complete the synthesis.

The tendencies of the emission spectrum of the phosphor and the relationship between the baking temperature and the solid solution content of the Group 2A sulfide will be described with reference to a ZnS—MgS system.

The entire emission spectrum shifts toward shorter wavelengths as the amount of MgS increases, but the integral emission intensity in the area of 420 nm or less is preferably 25% or more of the entire emission intensity. The integral emission intensity in the area of 400 nm or less is preferably 5% or more of the entire emission intensity. The amount of Mg is about 25 mol % of the sum of Zn and Mg when the integral emission intensity in the area of 400 nm or less is 5% or more of the entire emission intensity. Further crystal mixing of MgS is required in order to make the integral emission intensity in the area of 400 nm or less to be 5% or more of the entire emission intensity, but MgS ordinarily only forms a solid solution to about 25 mol % with respect to ZnS at room temperature. When this level is exceeded, rock salt-type MgS having a different crystal structure than hexagonal ZnS begins to independently crystallize out. This MgS is very vulnerable to water and converts to MgO and Mg(OH)₂, which causes degradation in the phosphor performance.

In the present invention, MgS having a molar concentration of 25 mol % or higher can be formed into a solid solution by rapid cooling from the baking temperature. The higher the baking temperature is, the higher the solid solution content of MgS there is at that temperature. When baked at a temperature of 1,020° C., for example, a solid solution of MgS forms at a molar concentration of about 25 mol %. When baked at a temperature of 1,200° C., the molar concentration increases to 50 mol %. The baking temperature, solid solution content, and tendencies of the emission spectrum are the same when A in the general formula of the phosphor of the present invention is any element selected from Be, Ca, Sr, and Ba, or any combination of these elements.

A phosphor which retains the solid solution content at the baking temperature can be obtained by rapid cooling from a high baking temperature. For example, the solid solution content of Mg can be set to the above-stated value by using a baking oven that has a rapid cooling rate, and rapidly cooling the material to room temperature at a rate of about 30° C./min. Other cooling methods include a method in which a large quantity of gas is allowed to flow to carry out cooling after a holding period, and a method in which the material is transferred to a highly thermally conductive container floating in water. When naturally cooled inside the oven, the cooling rate is about 1° C./min to 100° C./min, but when rapidly cooled in water or another medium, a cooling rate that is higher that these values can be obtained. Depending on the structure of the baking oven, the in-water rapid cooling method may be preferred in cases in which the baking temperature is high. When the in-water cooling method is used, the cooling process is preferably carried out in an inert gas, but there are no significant problems when in-atmosphere cooling is used because rapid cooling is carried out in a very short period of time.

Thus, the ions or atoms of the activator that has entered the interstices are unstable. Therefore, the ions or atoms are ejected from the interstices, strain is introduced into the crystal lattice by rapid cooling, and the emission intensity may be reduced. For this reason, the material is annealed for a long period of time during rapid cooling and prior to reaching room temperature, or after rapid cooling to room temperature, thereby having the effect of stabilizing the interstitial atoms and removing strain in the crystal lattice.

Moreover, the EL brightness can be improved by intentionally introducing strain inside the phosphor, and forming a twin crystal (stacking fault) at a high density prior to annealing for removing the strain. As the annealing temperature is increased, the crystallinity is improved through the removal of strain, the dispersion density of the electroconductive phase is increased, and the brightness is improved, but when the temperature exceeds 800° C., the interstitially introduced activator may be ejected, the sulfur component in the phosphor may sublimate, and the emission intensity on the long-wavelength side may increase, resulting in a reduction of B-Cu emission intensity. Crystallinity is not improved when the annealing temperature is less than 100° C., and the annealing temperature is preferably about 700° C. Examples of methods of introducing strain include applying mechanical stress to the phosphor powder after baking, and irradiating the phosphor powder using an electron beam. The twin-crystal density is further increased when mechanical stress is applied, though a limited amount of twin crystal is formed inside the phosphor after baking. When a powder containing such a twin crystal is annealed, the Cu, Ag, or Au contained in the phosphor may separate at twin boundaries during annealing and function as an electroconductive phase.

The starting materials before baking are preferably mixed in a nonaqueous solvent or in a nonoxidizing gas. The Group 2A sulfide of the starting material of the phosphor matrix is unstable and hydrolyzes, particularly by contact with water. The material oxidizes in dry air, and is therefore incapable of yielding a mixed crystal phosphor. Also, Group 2A oxides may become intermixed as impurities after baking, and other problems may occur. In the present invention, a phosphor can be obtained as designed and in accordance with the charged concentration by mixing the starting material with ethanol or another solvent, using an evaporator to dry the starting material in an inert gas, and preventing deterioration in the starting material. Examples of inert gas include nitrogen and argon. It was discovered that B-Cu light can be emitted by baking the material in hydrogen sulfide gas, hydrogen gas, nitrogen gas, or argon gas, and that, in particular, high luminance is generated by baking the material in hydrogen gas, hydrogen sulfide gas, or argon gas. The reason for this is thought to be that sulfur from ZnS can be prevented from sublimating when baking is carried out in a gas that contains hydrogen sulfide.

### 3 When the Activator is Cu

The phosphor of the present invention can advantageously use Cu as an activator. Specifically, a phosphor is provided that is characterized in that the activator E in the general formula is Cu, x satisfies the expression 0<x<1, and the wavelength of a part of the electroluminescent emission spectrum measured by applying an AC electric field is in a region that is 400 nm or less.

The emission wavelength of a ZnS-based phosphor generally has a broad shape. In the present invention, this means that the peak wavelength of the emission spectrum is not 400 nm or less, but rather that the tail end on short-wavelength side is within a range of 400 nm or less. In the present invention, the tail end on the short-wavelength side can be shifted to 400 nm or less by enlarging the band gap of the base metal and adjusting of the content of both the activator and the co-activator.

The density of the activator Cu is preferably 0.006 to 6 mol % with respect to the metal elements (the sum of Zn and A in the general formula) of the phosphor matrix. A B-Cu emission does not easily occur when the ratio is less than the above-stated range, and saturation occurs when the ratio is greater than the above-stated range. A range of 0.2 to 1 mol % is more preferred.

Examples of the co-activator D include Al, Ga, Cl, and F. Al and Cl are preferred from the standpoint of starting material costs. The concentration of the co-activator is preferably 0.1 to 90 mol % of the concentration of the activator. B-Cu emission intensity is low when the concentration is greater than the above-stated range, and a B-Cu emission does not easily occur when the concentration exceeds the above-stated range. A range of 0.1 to 60 mol % is more preferred.

The ratio of the co-activator with respect to the activator as described above refers to the concentration of the components in the phosphor, and the ratio does not necessarily match the concentration ratio when the starting material powders are prepared. In other words, the crystallinity must be increased in order to prepare a phosphor that emits light at high brightness, and a large amount of fusing agent is ordinarily used to achieve this end. The fusing agent becomes a liquid phase at a low temperature, and KCl, NaCl, and other chlorides are generally used. Increasing the concentration of the fusing agents means that the concentration of the co-activator in the starting material is increased, and the co-activator concentration is increased more than the activator concentration in the starting material. However, since the solid solution content of Cl in ZnS is about 0.1 mol %, the concentration of the activator in the phosphor can be made greater than the concentration of the co-activator regardless of the fusing agent by making the concentration of the activator in the starting material to be greater than 0.1 mol %. This phenomenon becomes prominent when Cu is used as an activator. When Cu is used as activator, a B-Cu emission is often obtained even when the concentration of the fusing agent is increased. The reason for this is that Cu more easily enters the interstices than Ag.

As described above, annealing is effective because strain is generated in the crystal lattice of a phosphor that has been rapidly cooled after baking in the manufacture of the phosphor. Annealing not only improves the crystallinity of the phosphor matrix by removing strain, but also produces the following effects. Specifically, a large number of crystal dislocations and twin crystals (stacking defects) occur when strain is introduced inside the phosphor, but annealing again causes the excessive Cu component of the Cu introduced as an activator to diffuse in the crystal dislocations and twin boundaries. The excessive Cu component forms Cu₂S and is dispersed as an electroconductive phase, and the brightness during EL emissions is improved. There are cases in which the precipitate at dislocations and grain boundaries is Cu₂S, and there are cases in which the precipitate is Cu₁₋ₓS. There are also cases in which Cu atoms separate at a high density at the twin boundaries.

In the method described above, Cu₂S particles are also deposited on the surface of the phosphor containing Cu₂S. When Cu₂S particles, which have high electrical conductivity, are present on the surface of the phosphor, an electric field is formed over the surface when an AC electric field is applied, voltage is not effectively applied inside the phosphor, and the emission intensity is reduced. The particles are therefore preferably removed by etching or another method.

In a composition in which the MgS content is 50 mol %, the peak wavelength of the emission spectrum is about 400 nm, the tail end of the short-wavelength side is about 350 nm, and the cumulative emission intensity at 400 nm or less increases to nearly 36%.

Cu is added as an activator to the phosphor of the present invention. The phosphor of the present invention can therefore emit light even when an electron beam or UV rays are irradiated. Cu functions as an activator, whereas any excess of Cu forms a Cu sulfide after baking and is dispersed in the phosphor. Since the electrical conductivity of the Cu sulfide is high, an applied electric field has a strength that is about two orders of magnitude greater than voltage locally applied in the phosphor, and high EL emission intensity can be obtained.

### 4 When the Activator is Ag

The phosphor of the present invention can advantageously use Ag as the activator E. In other words, a phosphor is provided that is characterized in that the activator E in the general formula is Ag, x satisfies the expression 0<x<1, and the Ag activator is added in a molar concentration that is equal to or greater than the molar concentration of the co-activator D.

In the present invention, the added amount of activator and co-activator, the added amount of Group 2A sulfide as the mixed crystal, the baking conditions, and the mixture of the starting materials are adjusted so that a greater amount of Ag enters the interstices of the ZnS-based phosphor.

As described above, there are cases in which the emission spectrum of the phosphor of the present invention has two peak wavelengths. In particular, the emission spectrum often has two PL peaks when Ag is used as an activator. Conversely, when Cu is used, the emission spectrum often has a single peak. This is due to the fact that Cu more easily enters the interstices than Ag. The emission peak intensity on the short-wavelength side of the two emission peaks is preferably 20% or more of the emission peak intensity on the long-wavelength side. When the emission peak intensity is 20% or more, the emission spectrum during electron beam irradiation results in a CL spectrum in which only the peak wavelength on the short-wavelength side represents a peak wavelength. Also, the ZnS-Group 2A sulfide phosphor of the present invention emits light at wavelengths ranging from 355 to 387 nm, which are UV rays required for exciting a photocatalyst and for use in insect trapping, UV exposure, resin curing, and various other applications. Since it is possible to obtain emissions in the vicinity of 365 nm, which is a wavelength having broad applicability, PL, CL, and EL emission elements that use the phosphor of the present invention can be expected to be used as a light source in such applications.

There are two types of crystal structure of ZnS, i.e., an α-type, which is a high-temperature phase, and a β-type, which is a low-temperature phase. The α-type has large gaps in the crystal lattice. The ZnS phosphor of the present invention is baked and synthesized at 900 to 1,200° C. A large amount of the α-type, which has a large lattice constant, can be added, and a crystal phase that facilitates interstitial entry of a larger amount of Ag can be obtained by baking and rapidly cooling the material thereafter in a cooling rate range of 1° C./min to 100° C./min. In Japanese Laid-open Patent Application No. 2002-231151, the α-phase content is 0 to 40%. The content of the α-phase, which has a large lattice constant, is low, and it is believed that the Ag activator does not easily entry into the gaps of the crystal lattice. This is thought to be one of the reasons that a B-Cu emission cannot be obtained.

As described above, the phosphor matrix of the present invention is a mixed crystal in which a Group 2A sulfide and at least one sulfide selected from the group consisting of BeS, MgS, CaS, SrS, and BaS are formed into a solid solution. In this case, the concentration of the sulfide is preferably 5 to 50 mol %, and more preferably 15 to 50 mol %.

Atoms or ions that that have entered the interstices are unstable, and are therefore ejected from the interstices during cooling. An advantage of the cooling process, however, is that the interstitial atoms can be stabilized. There is also a problem in that strain is also introduced into the crystal lattice by the rapid cooling, and the emission intensity is reduced. However, this can be solved by prolonged annealing as described above. In this case, prolonged annealing is preferably carried out at a low temperature of about 100° C. to 500° C. When annealed at 500° C. or higher, interstitial Ag is ejected, which may lead to reduced B-Cu emission intensity. By carrying out these procedures, high-concentration Ag can more easily enter the interstices, a B-Cu emission in the UV region can occur, and the emission intensity can be maximally improved.

At least one type of element selected from Al and Ga, which are Group 3B elements, and F, Cl, Br, and I, which are Group 7B elements, is preferably used as the co-activator D. The concentration of the Ag activator is preferably 0.006 to 6 mol % with respect to the metal elements (the sum of Zn and A in the general formula) of the phosphor matrix, and more preferably 0.01 to 1 mol %.

The phosphor of the present invention demonstrates emissions in the UV region in PL and CL applications, and can also be used in EL applications by combining Cu₂S or another Cu—S-based compound, and carbon nanotubes or another electrically conductive substance. Therefore, a UV-emitting EL device can easily be manufacture by substituting the phosphor of the present invention in place of the phosphor of known EL panels.

### 5 When the Activator is Ag and Au

In the phosphor of the present invention, Ag and Cu are advantageously used as activators as described above, but a more preferable mode is the use of Ag and Au as activators. Specifically, a phosphor is provided that is characterized in that the activator E in the general formula is Ag and Au, x is 0≦x<1, and electroluminescent light is emitted. Following are the reasons that Ag and Au are preferred.

When Cu is the activator, Cu¹⁺ ions (0.6 A) are substantially the same size as Zn²⁺ ions (0.6 A). Therefore, the ions easily enter the interstices and B-Cu light is emitted. Cu ions that could not enter the interstices are furthermore ejected away from the crystal lattice and react with the S of ZnS to form highly electroconductive Cu₂S or another copper sulfide at the grain boundaries of ZnS crystal. When an AC electric field is applied to an inorganic EL device that uses such a phosphor, the value of the applied electric field is equal to or greater than that of the locally applied electric field, and an EL emission is produced. However, since the acceptor level of Cu is deep, it is difficult to considerably reduce the wavelength of the EL emission.

On the other hand, when the Ag is the activator, the size of the Ag ions (1.0 A in a four-coordinated structure) is greater than the size of the Cu ions, and the Ag ions cannot enter the interstices as easily as the Cu ions, but Ag ions can be made to enter the interstices by forming a solid solution of Mg in ZnS and increasing the size of the lattice to be able to emit B-Cu light at 400 nm or less. However, Ag ions that cannot enter the interstices end up forming Ag₂S or other Ag sulfides, which have low electrical conductivity, and concentrating the electric field in the above-described manner becomes impossible. Therefore, EL emissions are relatively low. Only Cu, which has ions with small radii, enters the interstices, and the wavelength of the B-Cu emission is brought to 450 nm when Ag and Cu are simultaneously added as dopes.

In view of this situation, Ag and Au are simultaneously added as the activator E. An EL emission having a shorter wavelength can thereby be obtained than when the activator is Cu alone. Since the ion radius (1.37 A) of Au¹⁺ is greater than that of Ag, only Ag enters the interstitial gaps when the two are simultaneously doped, and extra Au ions are left as Au at grain boundaries. This is because Au does not react with S. Since Au has extremely high electrical conductivity, EL emissions can be very readily produced.

The present phosphor can be obtained by increasing the sum of the molar concentrations of Ag and Au, which constitute the activator E, to a level above that of the sum of the molar concentrations of the co-activator D. An activator that has the same or greater concentration than the co-activator will enter the interstitial gaps without substitution in the Zn positions because electrical neutrality is maintained. Also, the molar concentration of the Ag activator is preferably greater than the sum of the molar concentrations of the co-activator D.

The sum of the molar concentrations of Ag and Au is preferably 0.01 to 1 mol % with respect to the metal elements (the sum of Zn and A in the general formula) of the phosphor matrix. When the sum is less than 0.01 mol %, the PL and CL emission intensities are reduced and the EL emission intensity is considerably reduced. When the sum exceeds 1 mol %, the emission intensity saturates. The molar concentration of Ag is even more preferably 0.01 to 0.5 mol % with respect to the metal elements of the phosphor matrix.

The molar concentration of the co-activator is preferably 0.1 to 80 mol % of the sum of the molar concentrations of Ag and Au. When the sum is less than 0.1 mol %, the emission intensity is reduced. When the sum exceeds 80 mol %, the intensity of the long-wavelength DA pair emission that accompanies the B-Cu emission begins to increase, and such a situation is not preferred. The molar concentration of the co-activator is even more preferably 0.05 to 80 mol % of the molar concentration of Ag.

Not only Ag, but also Au may enter the interstices because the difference between the ion radii of Ag and Au is not as considerable as the difference between the radii of Cu and Ag. In this case, the emission spectrum has two peaks. The peak on the short-wavelength side is due to Ag, and the peak on the long-wavelength side is due to Au. In order to increase the peak intensity on the short-wavelength side, the addition amounts of Ag and Au, the addition amount of the co-activator, and other parameters must be optimized. Additionally, the cooling rate from the baking temperature is also important. Essentially, Ag entry into the interstitial gaps is facilitated as the cooling rate is increased, but when the cooling rate is excessively high, Au ions having larger ion radii tend to enter more readily. As described above, a phosphor can be obtained in which the solid solution content of a Group 2A sulfide (second component) at the baking temperature is maintained by rapid cooling from the baking temperature, but when rapid cooling is excessively rapid, care must be taken because Au more readily enters the interstices.

As described above, strain is introduced inside the rapidly cooled phosphor. Annealing not only improves the crystallinity of the phosphor matrix by removing the strain, but also produces the following effects. In other words, a large number of crystal dislocations and stacking defects are produced by introducing strain inside the phosphor, but the excess components of the Ag and Au introduced as activators not incorporated into the ZnS are re-diffused into the crystal dislocations and stacking defects by annealing. The excess components may also precipitate to the surface of the phosphor. In the case of Ag, the element transforms to Ag₂S, and in the case of Au, the element remains as Au and forms two phases, which are very densely dispersed in crystal dislocation areas and crystal grain boundary areas. Of these two phases, Ag₂S has low electrical conductivity and therefore does not produce EL emissions, but Au has very high electrical conductivity, and brightness is improved when EL emissions are produced. When the ion radii of Au and Ag are considered, the smaller-size Ag readily enters the ZnS interstices, and Au has a high probability of existing as two phases.

These methods also deposit Au particles on the surface of the phosphor in which Au has been introduced. When highly electroconductive Au is present on the surface of the phosphor, an electric field is spread across the surface when an AC electric field is applied, voltage cannot be effectively applied insider the phosphor, and the emission intensity is reduced. Therefore, Au on the surface of the phosphor is preferably removed by etching or another method.

When Ag and Au are both doped in the interstices in the present invention, at least two peaks should appear in the emission spectrum, but in an actual emission spectrum, the peak often appears as a single peak that spreads out broadly. When a B-Cu emission is produced, a G-Cu emission will also always be produced. Since two activators, i.e., Ag and Au, are used, a G-Cu emission (the emission wavelengths thereof also change in accordance with the bandgap of the phosphor matrix) for each activator is produced, but when the intensities of these emissions are weak, a clear peak is not obtained. Therefore, the shapes of the CL and EL spectra often have tail ends that extend lengthily on the long-wavelength side. Since strong excitations generally produce an intense B-Cu emission, the relative emission intensity with respect to the entire emission intensity is often increased in comparison with UV excitation when an electron beam or an AC electric field is applied to the phosphor of the present invention. When the applied voltage and frequency are increased (e.g., about 500 V and 3,000 Hz) in an EL emission, B-Cu light is generated with greater intensity than G-Cu light.

The emission spectrum of a phosphor that is caused to emit B-Cu light by doping with Au and Ag is therefore broad and is often shaped with one or two peaks.

In contrast, B-Cu emission-producing ZnS:Cu, Cl has EL emissions at substantially the same wavelength as a PL spectrum. Since G-Cu emissions (about 525 nm) are always produced when B-Cu emissions are produced, the emission spectrum becomes bilaterally asymmetrical and shifts to about 600 nm at the tail end of the long-wavelength side. The same applies to the case in which the phosphor matrix is a mixed crystal such as ZnS—MgS.

A desirable situation is obtained when the peak wavelength at least on the short-wavelength side of the emission spectrum is 420 nm or less because rutile TiO₂ can be excited. An even more desirable situation is to increase the solid solution content of the Group 2A sulfide, to increase the bandgap of the phosphor matrix, and to bring the wavelength to 400 nm or less, thereby enabling anatase TiO₂ to be excited.

### 6 Fluorescent Lamp

The phosphor of the present invention can be advantageously used in a fluorescent lamp. Specifically, the present invention provides a fluorescent lamp in which the above-described phosphor is used and which is characterized in comprising a hot cathode or an field-emission cold cathode, an anode, and a phosphor layer formed on the anode, wherein the phosphor has a function for emitting UV rays having a wavelength of less than 400 nm by using cathode luminescence, and x in the general formula satisfies the expression 0<x≦0.5.

In particular, insects are attracted to UV rays having a wavelength of 365 nm. This wavelength is also used in exposure devices and technologies for curing resins with UV rays. UV rays that are centered about this wavelength as a peak have very broad application, and various applications can be developed because the present invention uses phosphors having a main emission band in this range of wavelengths.

Excess heat and other factors that present a problem when an incandescent lamp or the like is used are no longer required, response time can be improved, and power consumption can be reduced by using a field-emission cold cathode as an electron emitter for the cathode. In particular, the amount of electrons that are emitted is increased by using carbon nanotubes. For this reason, a fluorescent lamp can be used as a UV lamp, and brightness can be sufficiently increased. By forming carbon nanotubes as the electron emitter on the cold cathode surface and disposing a gate electrode so as to cover the outer side of the emitter, a fluorescent lamp without brightness nonuniformity can be obtained because electrons are drawn out from the entire spherical surface of the field-emission cold cathode and are caused to collide with the entire area of the light-emitting portions of the inner surface of the light-emission container to emit light. The amount of emitted electrons is increased and brightness is further enhanced by vertically growing the carbon nanotubes on the cathode surface. The same effect can be achieved even when a dull-tipped diamond columnar crystal is used in place of carbon nanotubes.

A field-emission fluorescent lamp or display (field-emission display) having excellent color purity can be obtained by directly using the basic principles of the present UV-emitting fluorescent lamp and forming a phosphor layer having a function for emitting visible light by UV irradiation.

### 7 Surface Emission Device

The present invention provides a surface-emitting device characterized by having a phosphor that emits light by inorganic electroluminescence and is a compound material composed a first phosphor having a function whereby UV rays or visible light having a peak wavelength of 460 nm or less is emitted by applying an AC electric field, and a second phosphor that is caused to emit visible light by irradiation with visible light or UV irradiation.

The phosphor of the present invention can be advantageously used in surface-emitting devices. In other words, the present invention provides a surface-emitting device characterized in having a surface emitter that is a combination of a first phosphor and a second phosphor, wherein the first phosphor is the phosphor of the above-described invention that emits light by inorganic electroluminescence and has a function whereby UV rays or visible light having a wavelength 460 nm or less is emitted by the application of an AC electric field, and wherein the second phosphor is caused to emit visible light by irradiation with visible light rays or UV rays.

A common inorganic EL sheet is caused to emit visible light by the application of an AC electric field to electrodes formed above and below a layer in which a phosphor powder for producing EL emissions is dispersed in resin having a high dielectric constant. In the present invention, an EL phosphor powder (first phosphor) is mixed with a PL phosphor (second phosphor) having a function for emitting visible light that has a longer wavelength than the light used to irradiate the phosphors, making it possible to obtain a surface-emitting device that also has persistent characteristics. When the device is used as a backlight for a mobile phone or clock, the backlight can continue to emit light even after operation has ended.

The first phosphor is preferably one that emits UV rays having a wavelength of less than 400 nm, and any aspect of the phosphor of the present invention can be advantageously used as long as light can be adequately emitted by EL. For example, the first phosphor is expressed by the general formula Zn₍₁₋ₓ₎AₓS:Cu, D, wherein A is at least one type of Group 2A element selected from the group consisting of Be, Mg, Ca, Sr, and Ba; D is a co-activator comprising at least one element selected from a Group 3B element and a Group 7B element; x is a mixed crystal ratio that satisfies the expression 0<x≦0.5; and the phosphor preferably has a B-Cu light-emitting function. Examples of the activator D include Al, Ga, Cl, and F, but Al and Cl are preferred from the standpoint of starting material costs.

When Cu is doped, a portion of the added Cu remains inside the phosphor as highly electroconductive Cu₂S or another sulfide, and when an AC electric field is applied to an EL device that uses this phosphor, an EL emission is produced because of the concentrated electric field and other reasons. The emission wavelength depends on the bandgap of the semiconductor that is acting as the phosphor matrix, and light having a shorter wavelength can be emitted in correlation with a larger bandgap. Accordingly, when a B-Cu emission is to be produced, ZnS:Cu, Cl, Al (450 to 460 nm) and Zn_{0.7}Mg_{0.3}S:Cu, Al (421 nm) can be used, for example.

The EL-emitting first phosphor preferably has a function whereby UV rays having a wavelength of less than 400 nm are emitted by the application of an AC electric field. This is because a user will operate a mobile phone or other apparatus for a short time, and it is preferable to use UV rays that have a high level of energy capable of exciting a persistent phosphor in a short period of time. A UV-emitting phosphor that has an emission peak wavelength of less than 400 nm is preferred, and a range of 300 to 375 nm is particularly preferred. This is because the second phosphor described below emits light most efficiently when UV rays having wavelengths in this range are used.

A first phosphor that emits EL light in this wavelength range is expressed by the general formula Zn₍₁₋ₓ₎AₓS:Ag, D, wherein A is at least one type of Group 2A element selected from the group consisting of Be, Mg, Ca, Sr, and Ba; D is a co-activator comprising at least one element selected from a Group 3B element and a Group 7B element; x is a mixed crystal ratio that satisfies the expression 0≦x≦0.5; and the phosphor preferably has a B-Cu light-emitting function. Examples of the activator D include Al, Ga, Cl, and F, but Al and Cl are preferred from the standpoint of starting material costs.

The light-emitting mechanism of this phosphor is exactly the same as ZnS:Cu, Cl, and such emissions are referred to as B-Cu emissions even when Ag has been doped. It is possible, for example, to use ZnS:Ag, Cl, Al (399 nm) and Zn_{0.65}Mg_{0.35}S:Ag, Cl, Al (369 nm). In the case of an Ag system, Ag₂S is formed in the same manner as a Cu system, but since the electrical conductivity is low, electric field concentration and other effects do not occur, and an EL emission is therefore not produced. Accordingly, in the case of an Ag system, an EL emission can be produced when a Cu₂S phase is compounded with the fabricated phosphor using other means.

In addition to these phosphors, other UV-emitting phosphor candidates include CaS:Gd, F (emissions at 315 nm), CaS:Cu (emissions at 400 nm), CaS:Ag, K (emissions at 388 nm), and CaS:Pb (emissions at 360 nm). Although having low chemical stability in the atmosphere, calcium oxide is also a phosphor that emits light very well using an electron beam, and examples of such phosphors include CaO:F (emits light at 335 nm), CaO:Cu (emits light at 390 nm), and CaO:Zn, F (emits light at 324 to 340 nm). There are also UV-emitting phosphors composed of materials doped with Gd alone or both with Gd and with Pr, but the emission efficiency is somewhat less. There are ZnF₂:Gd and other phosphors that emit UV rays having an intense bright line spectrum in the vicinity of 311 nm. With these phosphors as well, an EL emission cannot be produced if Cu₂S or another other highly electroconductive phase is not compounded in the same manner as ZnS:Ag, Cl or the like.

Examples of the second phosphor that can be used include ZnS:Cu, Cl and other traditional phosphors, but oxide-based phosphors are preferred because of their longer persistence, excellent moisture proofness, and other qualities. For example, compounds expressed as MAI₂O₄ are preferred. In the formula, M is at least one metal element selected from the group consisting of Ca, Sr, and Ba. The second phosphor is characterized in that this compound is used as the base crystal, Eu acting as the activator is preferably added in an amount of 0.002 to 20 mol % with respect to the metal element expressed by M, and at least one or more elements selected from the group consisting of Ce, Pr, Nd, Sm, Tb, Dy, Ho, Er, Tm, Yb, and Lu are furthermore added as a co-activator in an amount of 0.002 to 20 mol % with respect to the metal element expressed by M. Examples include CaAl₂O₄: Eu, Nd; SrAl₂O₄:Eu, Dy; and BaAl₂O₄:Eu, Lu. Also advantageously used are Sr₄Al₁₄O₂₅:Eu, Dy; Y₂O₂S:Eu, Mg, Ti; Y₂O₂S:Eu, Mg, Ti and other oxide-based phosphors.

The surface-emitting device of the present invention can be manufactured using exactly the same steps used to manufacture an ordinary EL sheet. Considering the emission brightness, persistence, and other parameters during electroluminescent energizing, the ratio of the first phosphor with respect to the entire phosphor is preferably 30 to 70 vol %.

When the surface-emitting device of the present invention containing a persistent phosphor as the second phosphor is used as a backlight for a mobile phone or clock, the backlight can be lighted and screen displayed by electroluminescence when the user is operating the device, and since the backlight continues to emit light even after operation has ended and power has switched off, the backlight can save power and be viewed even in dark locations.

A variety of phosphors can be caused to emit visible light having good color purity by irradiation with UV rays. Therefore, when a UV-emitting phosphor is used as the first phosphor, and a phosphor that is caused to emit visible light having good color purity by irradiation with UV rays is used as the second phosphor, a surface-emitting device can be obtained that has high brightness and that emits visible light with good color purity. In the present invention, ZnS:Ag, Cl; Y₂O₃S:Eu; and other compounds are examples of a phosphor that emits visible light having good color purity and that can be used as the second phosphor.

### BRIEF DESCRIPTION OF DRAWINGS

FIG. 1 An EL emission spectrograph of sample No. 6 of the first embodiment, measured by applying an AC electric field.

FIG. 2 A schematic diagram of an example of the fluorescent lamp of the present invention.

FIG. 3 A schematic diagram of the field-emission display of the present invention.

FIG. 4 A cathode luminescence spectrogram of sample No. 54 of the fourth embodiment.

### DETAILED DESCRIPTION OF THE PREFERRED EMBODIMENTS

### Fluorescent Lamp Configuration

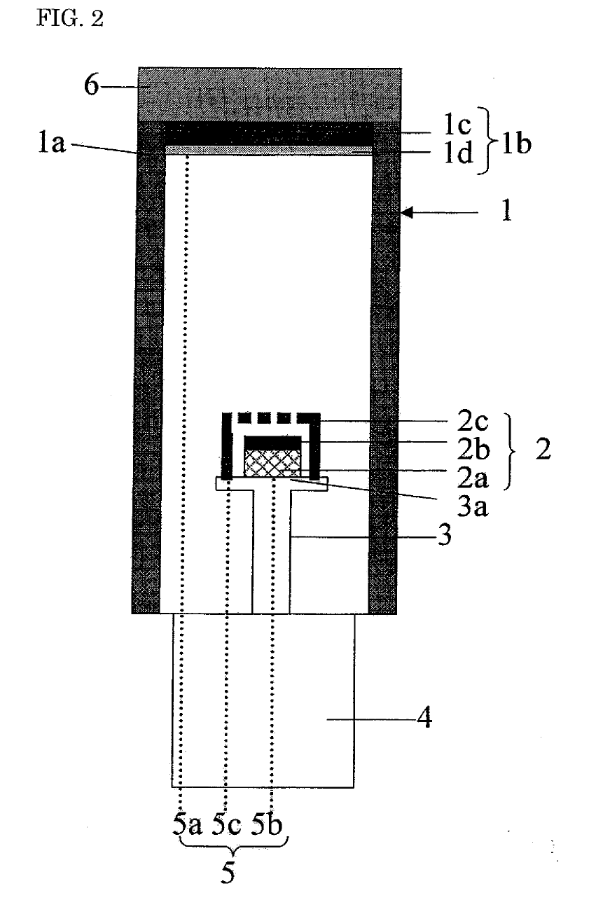

An example of the fluorescent lamp of the present invention will be described with reference to FIG. 2. FIG. 2 shows a schematic cross-sectional diagram of the fluorescent lamp. The fluorescent lamp comprises an interior-evacuated fluorescent container 1 that has a glass bulb 1a, a glass base 6, and a fluorescent portion 1b formed on the inner surface of the glass base 6; a field-emission cold cathode 2 that has a cold cathode 2a as an electrode, an electron emitter 2b formed on the external surface of the cold cathode 2a, and a gate electrode 2c that is disposed a prescribed distance away so as to cover the exterior of the electron emitter 2b and that draws out electrons from the electron emitter 2b; a support stand 3 that supports the cold cathode 2 in substantially the center area; and a socket 4 that fixes the support stand 3 and the fluorescent container 1. When in service, [the lamp] is electrically connected to an external circuit via the socket 4 and is supplied with power to operate. The fluorescent portion 1b has a phosphor layer 1c formed on the inner surface of the glass base 6, and a metal-backed layer (aluminum: Al) 1d acting as an anode formed on the surface of the phosphor layer 1c. In addition to functioning as an anode, the metal-backed layer 1d increases brightness, prevents ion collisions with the phosphor surface, and has other effects. The metal-backed layer 1d is formed by vapor deposition of an aluminum film on the surface of the phosphor layer. When the metal-backed layer is too thin, the number of pinholes increases and reflectivity toward the phosphor layer 1c is reduced; and when the layer is too thick, electron collisions with the phosphor layer 1c are inhibited and the luminous energy is reduced. Therefore, the aluminum metal-backed film is preferably formed to a thickness of about 150 nm. A lead pin 5a for the anode is electrically connected to the metal-backed layer 1d in order to apply voltage to the phosphor layer 1c during operation. Also, a lead pin 5b is connected to the cold cathode 2a, and a lead pin 5c is connected to the gate electrode 2c. The entire set of lead pins 5a, 5b, and 5c constitutes a guard pin 5.

The phosphor layer 1c is formed using the phosphor of the present invention. The phosphor has a function whereby UV rays that have a wavelength of less than 400 nm are emitted by CL with high efficiency. The layer is formed by coating a paste composed of a phosphor dissolved in a solvent to a glass substrate by printing, the slurry method, or another method, and thereafter drying the paste.

In the present invention, since an electron beam is used for excitation, the B-Cu emission intensity increases on the short-wavelength side. The peak wavelength of the emission is preferably kept in a range of 360 to 375 nm. This wavelength band is the most often used wavelength for curing UV-curing resins. The wavelengths centered about 365 nm are the wavelengths most preferred by insects, and are suitable for insect traps that use a fluorescent lamp.

The electroconductive material is preferably coated onto the surface or combined inside the present phosphor layer. When the fluorescent lamp using the present phosphor is operated, electrons emitted from the electron emitter are accelerated. When, however, the acceleration pressure is low, the phosphor becomes negatively charged, causing brightness saturation to decrease, or, in the worst case, light emission to be stopped altogether. Such charging can be prevented when an electroconductive material is coated onto or introduced into the surface of the phosphor layer. An electroconductive phase may also be combined inside the phosphor layer. ITO or the like can be used as the electroconductive material. For example, Cu₂S may be combined inside the phosphor layer in the same manner as common electroluminescent ZnS:Cu, Cl phosphors.

The electron emitter 2b constituting the field-emission cold cathode is disposed inside the glass bulb la on the support stand 3, which comprises an insulation material fixed to the socket 4. The cold cathode 2a is disposed on the upper end portion 3a of the support stand in an area that excludes the installation area on the stand, and the electron emitter 2b is formed on the surface of the cold cathode 2a. A cathode lead pin 5b for applying voltage is electrically connected to the cold cathode 2a.

Here, glass, a ceramic, or the like can be used as the insulation material of the support stand 3, and examples include forsterite, white board/potassium glass, and blue board/soda glass. Wiring material that can be used in semiconductor chips and the like can be used for the cold cathode 2a disposed on the support stand 3. Examples of materials that may be used include Ti, W, Mo, Fe, Cu, Ni, and alloys and compounds of these.

Any material that readily emits electrons may be formed on the surface of the cold cathode 2a and used as the electron emitter 2b. Examples of such materials include carbon nanotubes, diamond-like carbon (DLC), single-crystal diamond, multi-crystal diamond, noncrystalline diamond, noncrystalline carbon, and other carbon electron-emitting materials, as well as ZnO whiskers having pointed distal ends. In particular, carbon nanotubes can be advantageously used because they require low voltage for electron emissions and emit a considerable amount of electrons, thereby making it possible to produce an energy-saving fluorescent lamp that has higher brightness. Modes in which a carbon nanotube layer can be used include a carbon nanotube layer having a single-layer structure and a carbon nanotube layer having a coaxial multilayer structure. A metal that includes iron (Fe) is advantageously used to form the cold cathode 2a when a carbon nanotube layer is formed using thermal CVD. Printing, immersion coating, electrodeposition coating, electrostatic coating, a dry process, or another method may be used as the method for forming an electron emitter. Among these, a dry process is preferably used as the method for forming a carbon nanotube layer, which is advantageous in the present invention, on the surface of the cold cathode 2a. As used herein, the term “dry process” refers to laser vapor deposition, resistance heating, plasma method, thermal CVD, microwave plasma CVD, electron beam vapor deposition, or another method for forming nanotubes as the electron emitter by primarily using vapor-phase growth. Preferably used is a dry process in which a reactant gas is introduced in the presence of an inert gas or hydrogen gas, and it is more preferable to use a dry process in which carbon monoxide is introduced in the presence of hydrogen gas, and the thermally decomposed components are precipitated out as carbon nanotubes onto the surface of a cathode composed of an iron-containing metal. A smooth coating can be formed on the surface of the metal plate by forming carbon nanotubes directly on the cathode. For this reason, brightness nonuniformities can be prevented because electrons are uniformly emitted in all locations since the electric field is uniformly applied to the surface.

The gate electrode 2c is an electrode for drawing out electrons from the electron emitter 2b. The electrode is composed of a metal mesh, a perforated thin metal plate, or the like, and is formed into a shape that allows the electrons drawn out from the electron emitter 2b to arrive at the fluorescent portion 1b. Materials that may be advantageously used for the gate electrode 2c include 426 alloy, stainless steel (SUS 304), invar, Superinvar, and nickel (Ni). The gate electrode 2c is shaped to matches the shape of the electron emitter 2b, has a plurality of apertures, and is disposed at a prescribed distance away from the cold cathode. The apertures of the gate electrode can be formed by etching the thin metal plate or by using another method. An insulation layer (not shown) can be formed on the surface facing the electron emitter 2b of the gate electrode 2c in order to reduce reactive current absorbed by the gate electrode 2c and to effectively apply an electric field. The gate electrode 2c is preferably fixed to the support stand 3 using anchoring frit glass and a heat-resistant electroconductive paste. The gate electrode 2c can be affixed and the gate lead pin 5c can be electrically connected at the same time by using the frit glass and paste in combination.

In the configuration described above, voltage is supplied from an external circuit to the cold cathode 2a and gate electrode 2c via the lead pins 5b and 5c, an electric field is applied between the cold cathode 2a and the gate electrode 2c, and electrons are drawn from the carbon nanotube layer 2b. At this point, high voltage is supplied to the metal-backed layer 1d of the anode by way of the lead pin 5a, whereby the electrons emitted from the cold cathode 2 collide with the phosphor layer 1c of the anode to emit UV rays.

The gate electrode 2c and electron emitter 2b are disposed away from each other by a distance of about 0.1 to 1 mm. Electrons are drawn out from the entire electron emitter on the surface of the cold cathode by supplying voltage to the gate electrode 2c and electron emitter 2b. The electron emitter 2b itself is disposed in the center area of the fluorescent container 1, and brightness nonuniformities do not occur because the electrons drawn out form the electron emitter 2b collide with the entire phosphor layer formed on the inner surface of the fluorescent container 1 and emit light. Also, a fluorescent lamp that emits a large quantity of electrons and has high brightness can be obtained by using a nanotube layer as an electron emitter. Furthermore, since brittle components such as a filament are dispensed with by the use of such a field-emission cold cathode 2, a heating power source is no longer required, handling and manufacturing are simplified, and the service life of the phosphor is considerably extended. There is also an advantage in that extra heat and the like are not required and the response speed is high.

The present invention is not limited to the use of the cold cathode described above. In other words, application can also be made to fluorescent lamps that use a conventional hot cathode (thermal filament).

When the principles of the fluorescent lamp of the present invention are applied, a novel field-emission display (FED) can be produced. These principles are described below.

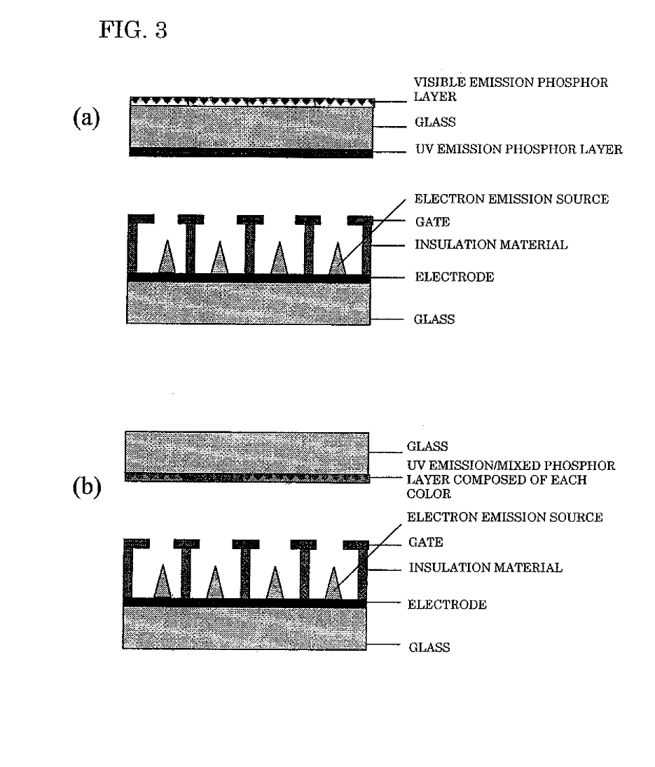

FIG. 3 shows the principles of the FED of the present invention. The configuration comprises an electron beam, gate electrodes, and an emission container in which a phosphor is formed in the inner surface, which is the same configuration as a conventional FED. The present invention is characterized in that a UV-emitting phosphor layer that can produce UV rays by using electron beam irradiation is formed as the phosphor on the exterior of a light-emission container (FIG. 3A), and, alternatively, in that a phosphor layer formed on the inner surface of the light-emission container comprises a mixture of a UV-emitting phosphor and a visible light-emitting phosphor (FIG. 3B).

With an ordinary FED, an electron beam is directed onto a phosphor, and red, green, and blue light is emitted. However, since there are few phosphors that are caused to emit light of each color with good efficiency and excellent color purity by irradiation with an electron beam, it is difficult to achieve a full color display. In contrast, with the present invention, the electron beam is first converted to UV rays with very high conversion efficiency, and the UV rays are directed onto a visible light-emitting phosphor to emit light of each color. There are many phosphors that are caused to emit light of each color with good efficiency and excellent color purity by irradiation with UV rays, which expands the range of options. A full color display having excellent color rendering properties can therefore be achieved. There are ZnS:Ag, Cl (blue color) and other systems among phosphors that are used for color televisions and have a main excitation band in the vicinity of 340 to 370 nm. Therefore, the present invention, which can very efficiently produce UV rays in this wavelength region, has advantages in comparison with Japanese Laid-open Patent Applications Nos. 8-127769 and 8-45438.

The present invention is described below using concrete examples.

### EXAMPLE 1

(Method for Preparing a Phosphor)

In the present embodiment, Cu is used as an activator. The procedure for preparing a Cu-activated Zn₍₁₋ₓ₎AₓS phosphor is described below.

(1) Starting Material

Phosphor matrices: ZnS, MgS, CaS, SrS, and BeS having a mean grain size of 1 μm

Activator: Cu₂S powder having a mean grain size of 1 μm

Co-activators: A1₂S₃, Ga₂S₃, NaF, NaCl, and NaI having a mean grain size of 0.5 μm

(2) Mixing

The starting materials having prescribed compositions were dispersed in various solvents and mixed for 3 hours by applying ultrasonic vibrations. The compositions in the samples are shown in TABLE 1 below. The second component in TABLE 1 refers to the Group 2A sulfide comprising the phosphor matrix. The solvents were volatilized and the starting material mixtures were dried using an evaporator in which dry argon was allowed to flow.

(3) Baking

The recovered starting material mixtures were placed in a 20×200×20 mm (height) lidded alumina crucibles, baked for 6 hours at prescribed temperatures in prescribed gases at a pressure of 1 atmosphere by using tube furnace, and thereafter naturally cooled in the ovens through which the gases were passed unchanged. For some of the samples, a 300×300×100 mm (height) container having a thickness of 0.5 mm was floated on water held in another container. The crucibles with the samples were removed in a group from the baking temperature, turned upside down, and transferred to the container floating on water and cooled.

(4) Introducing Strain

The baked samples were loaded into a press molding machine and pressed at a surface pressure of 50 MPa, and the molded product was thereafter pulverized using a ball mill to return the samples to a powder.

(5) Annealing

Some of the cooled samples were annealed for 2.5 hours at prescribed temperatures in argon gas. Unannealed samples were also prepared. Samples No. 1 and 2 after baking were not removed, but were annealed midway through cooling.

(6) Etching

100 cc of ammonia water was added per 4 g of phosphors in order to remove the Cu₂S present on the surface of the phosphor, 30 cc of hydrogen peroxide water was added, the components were allowed to stand for one hour, and the turbid fluid was then discarded. The step was repeated three times until the fluid became transparent. Next, the samples were washed five times using 1,000 cc of purified water per 4 g of phosphor.

(Method for Evaluating Emission Wavelength)

Concavities measuring 40×40×50 (depth) μm were formed in 50×50×1 mm quartz glass substrates, and aluminum was vapor deposited to a thickness of 0.1 μm to form a back electrode. The phosphors were mixed with castor oil using ultrasonic waves in a volume fraction of 35 vol % to form slurries, and the slurries were poured into the cavities. Lastly, an EL device was obtained by using a cover formed from a 50×50×1 mm quartz glass substrate on which a transparent electroconductive film (surface electrode) was coated to a thickness of 0.1 μm.

Lead wires were mounted on the two electrodes, and an AC voltage having a frequency of 3,000 Hz and a voltage of 300 V was applied. Emission spectra were measured using a photonic analyzer. Emission intensities were measured using an illumination meter in a measurement range of 310 to 900 nm.

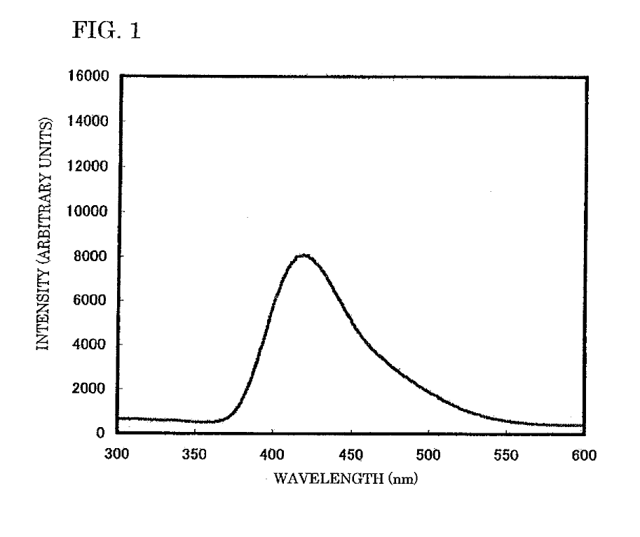

The optical power at 420 nm or less, and 400 nm or less was calculated as part of the entire emission intensity from these measurement results. The results are shown in TABLE 1. In FIG. 1, the second component expressed in mol % is a value that corresponds to the variable x in the general formula. The activator and co-activator concentrations and the co-activator/activator ratio expresses the content of metal elements of the phosphor matrix, i.e., the molar percentage with respect to the sum of Zn and A in the general formula. FIG. 1 also shows the EL emission spectrum of sample No. 6, which was measured by applying an AC electric field to the sample.

TABLE 1

| | | | Second | | | | | Co- | | | |
|---|---|---|---|---|---|---|---|---|---|---|---|
| | | | component | | | Activator | Co-activator | activator/ | Starting | Baking | Baking |
| | | Second | content | | Co- | concentration | concentration | activator | material | temperature | environ- |
| | Material | component | (mol %) | Activator | activator | (mol %) | (mol %) | (mol %) | solvent | (° C.) | ment |
| 1 | ZnS | MgS | 0 | Cu | Al | 0.6 | 0.3 | 50 | Ethanol | 1,000 | Ar |
| 2 | ZnS | MgS | 10 | Cu | Al | 0.6 | 0.3 | 50 | Ethanol | 1,000 | Ar |
| 3 | ZnS | MgS | 20 | Cu | Al | 0.6 | 0.3 | 50 | Ethanol | 1,000 | Ar |
| 4 | ZnS | MgS | 20 | Cu | Al | 0.6 | 0.3 | 50 | Ethanol | 1,000 | Ar |
| 5 | ZnS | MgS | 20 | Cu | Al | 0.6 | 0.3 | 50 | Water | 1,000 | Ar |
| 6 | ZnS | MgS | 30 | Cu | Al | 0.6 | 0.3 | 50 | Ethanol | 1,020 | Ar |
| 7 | ZnS | MgS | 40 | Cu | Al | 0.6 | 0.3 | 50 | Ethanol | 1,100 | Ar |
| 8 | ZnS | MgS | 50 | Cu | Al | 0.6 | 0.3 | 50 | Ethanol | 1,200 | Ar |
| 9 | ZnS | MgS | 50 | Cu | Al | 0.6 | 0.3 | 50 | Ethanol | 1,200 | N2 |
| 10 | ZnS | MgS | 50 | Cu | Al | 0.6 | 0.3 | 50 | Ethanol | 1,200 | N2 |
| 11 | ZnS | MgS | 50 | Cu | Al | 0.6 | 0.3 | 50 | Ethanol | 1,200 | N2 |
| 12 | ZnS | MgS | 50 | Cu | Al | 0.6 | 0.3 | 50 | Ethanol | 1,200 | N2 |
| 13 | ZnS | MgS | 50 | Cu | Al | 0.6 | 0.3 | 50 | Ethanol | 1,200 | N2 |
| 14 | ZnS | MgS | 50 | Cu | Al | 0.6 | 0.3 | 50 | Ethanol | 1,200 | N2 |
| 15 | ZnS | CaS | 20 | Cu | Al | 0.5 | 0.2 | 40 | Ethanol | 1,000 | H2 |
| 16 | ZnS | SrS | 20 | Cu | Cl | 0.5 | 0.2 | 40 | Ethanol | 1,000 | H2 |
| 17 | ZnS | BeS | 20 | Cu | F | 0.5 | 0.2 | 40 | Ethanol | 1,000 | H2 |
| 18 | ZnS | BeS | 20 | Cu | I | 0.5 | 0.2 | 40 | Ethanol | 1,000 | H2 |
| 19 | ZnS | BeS | 20 | Cu | Ga | 0.5 | 0.2 | 40 | Ethanol | 1,000 | H2S |
| 20 | ZnS | BeS | 20 | Cu | Ga | 0.007 | 0.005 | 71 | Ethanol | 1,000 | H2S |
| 21 | ZnS | BeS | 20 | Cu | Ga | 0.02 | 0.08 | 40 | Ethanol | 1,000 | H2S |
| 22 | ZnS | BeS | 20 | Cu | Ga | 1 | 0.4 | 40 | Ethanol | 1,000 | H2S |
| 23 | ZnS | BeS | 20 | Cu | Ga | 1 | 0.03 | 3 | Ethanol | 1,000 | H2S |
| 24 | ZnS | BeS | 20 | Cu | Ga | 5 | 0.005 | 0.1 | Ethanol | 1,000 | H2S |
| *25 | ZnS | BeS | 20 | Cu | Ga | 5 | 0 | 0 | Ethanol | 1,000 | H2S |
| 26 | ZnS | BeS | 20 | Cu | Ga | 7 | 3.2 | 46 | Ethanol | 1,000 | H2S |

| | | | | | Wavelength | Wavelength | | |
|---|---|---|---|---|---|---|---|---|
| | | | | | at tail end | at tail | | |
| | | | Annealing | Peak | of short- | end of long- | | |
| | | Introduction | temperature | wavelength | wavelength | wavelength | σ (400 nm >) | σ (420 nm >) |
| | Cooling | of strain | (° C.) | (nm) | side (nm) | side (nm) | intensity (%) | intensity (%) |
| 1 | In-oven cooling | No | 670 | 453 | 403 | 583 | 0 | 2.3 |
| 2 | In-oven cooling | No | 670 | 442 | 392 | 572 | 0.81 | 7.7 |
| 3 | In-oven cooling | No | 670 | 432 | 382 | 562 | 2.6 | 18.4 |
| 4 | In-oven cooling | Yes | 670 | 432 | 382 | 562 | 3.5 | 23 |
| 5 | In-oven cooling | Yes | 670 | 450 | 400 | 580 | 0.5 | 3.7 |
| 6 | In-oven cooling | Yes | 670 | 421 | 371 | 551 | 8.4 | 34.1 |
| 7 | Rapid cooling in | No | 670 | 411 | 361 | 541 | 19.7 | 50.4 |
| | water | | | | | | | |
| 8 | Rapid cooling in | No | 670 | 400 | 350 | 530 | 35.7 | 64.3 |
| | water | | | | | | | |
| 9 | Rapid cooling in | No | 670 | 400 | 350 | 530 | 23 | 55 |
| | water | | | | | | | |
| 10 | Rapid cooling in | No | None | 400 | 350 | 530 | 18 | 48 |
| | water | | | | | | | |
| 11 | In-oven cooling | Yes | None | 400 | 350 | 530 | 17 | 46 |
| 12 | Rapid cooling in | No | 730 | 401 | 351 | 531 | 24 | 56 |
| | water | | | | | | | |
| 13 | Rapid cooling in | Yes | 730 | 401 | 351 | 531 | 25 | 57 |
| | water | | | | | | | |
| 14 | Rapid cooling in | Yes | 850 | 410 | 360 | 540 | 18 | 47 |
| | water | | | | | | | |
| 15 | In-oven cooling | Yes | 730 | 434 | 384 | 564 | 3.5 | 30.3 |
| 16 | In-oven cooling | Yes | 730 | 436 | 386 | 566 | 3.5 | 30.3 |
| 17 | In-oven cooling | Yes | 730 | 422 | 372 | 552 | 8.5 | 35.3 |
| 18 | In-oven cooling | Yes | 730 | 422 | 372 | 552 | 8.5 | 35.3 |
| 19 | In-oven cooling | Yes | 730 | 422 | 372 | 552 | 8.6 | 35.7 |
| 20 | In-oven cooling | Yes | 730 | 422 | 372 | 552 | 1.6 | 9.1 |
| 21 | In-oven cooling | Yes | 730 | 422 | 372 | 552 | 7.4 | 28.3 |
| 22 | In-oven cooling | Yes | 730 | 422 | 372 | 552 | 7.3 | 28 |
| 23 | In-oven cooling | Yes | 730 | 422 | 372 | 552 | 7.1 | 26.8 |
| 24 | In-oven cooling | Yes | 730 | 422 | 372 | 552 | 6.7 | 24.1 |
| *25 | In-oven cooling | Yes | 730 | 600 | 550 | 730 | 0 | 0 |
| 26 | In-oven cooling | Yes | 730 | 422 | 372 | 552 | 6.2 | 22 |

Overall, the emission spectrum shifted to the short-wavelength side as the amount of MgS increased, and the UV ray intensity ratio R_{UV} increased at or below 420 nm and at or below 400 nm.

After in-oven cooling, when the material to which strain had been introduced (e.g., No. 4) was compared with material to which strain had not been introduced (e.g., No. 3), R_{UV} was increased. The reason for this is believed to be that emissions were produced from more locations during the application of an electric field because dislocations and defects were produced inside the phosphor, and the Cu diffused by annealing was transformed to Cu₂S due to these dislocations and defects. For samples (No. 5) mixed in an aqueous solvent, R_{UV} decreased as a result of the emission wavelength having shifted to the long-wavelength side. This is thought to be due to the fact that MgS oxidized in the mixture, and the Mg ratio in the ZnS—MgS mixed crystal matrix was reduced. The MgS content of the solid solution and R_{UV} were increased by using the in-water cooling method (e.g., Nos. 7 and 8). When baked in an N₂ atmosphere (No. 9), R_{UV} was somewhat reduced in comparison with when baked in an Ar atmosphere (No. 8). When annealing was not used (Nos. 10 and 11), R_{UV} was somewhat reduced in comparison with the use of annealing (No. 12). When the annealing temperature after in-water cooling was increased to 730° C. (No. 12), R_{UV} was somewhat increased in comparison with when the annealing temperature was 670° C. When strain has been introduced after in-water cooling (No. 13), R_{UV} was further increased in comparison with material to which strain had not been introduced (No. 12). When the annealing temperature was a high temperature of 850° C., R_{UV} was somewhat reduced (No. 14).

UV rays were emitted at or below 400 nm (No. 15 to 19) even when CaS, SrS, and BeS were used as the second component of the phosphor matrix, and Al, Cl, F, I, and Ga were used as the co-activator. When the concentration of the co-activator with respect to the activator exceeded 60 mol %, the UV intensity ratio was reduced (No. 20). When the co-activator/activator ratio was varied, R_{UV} was somewhat reduced when the ratio was low (Nos. 21 to 24). When a co-activator was not added, long-wavelength emissions were not produced, and R_{UV} was reduced to zero (No. 25). When the concentration of the activator with respect to the metal elements of the phosphor matrix exceeded 5 mol %, R_{UV} was somewhat reduced (No. 26).

### EXAMPLE 2

(Method for Preparing a Phosphor)

Ag was used as the activator in the present example. The procedure for preparing an Ag-activated Zn₍₁₋ₓ₎AₓS phosphor is described below.

Dispersed in ethanol were a ZnS powder used as a starting material in the amounts shown in composition tables 1 to 9; a Group 2A sulfide powder selected from BeS, MgS, CaS, SrS, and BaS powders; an Ag₂S powder, which was a source for supplying the Ag activator; and a powder selected from Al₂S₃, Ga₂S₃, NaF, NaCl, NaBr, and NaI powders, which were sources for supplying the co-activators Al, Ga, F, Cl, Br, and I). Ultrasonic vibrations were then applied for 3 hours to mix the system. The values in the tables express the weight (g) of the starting material powders. However, the compositions shown in these tables are merely examples. An evaporator in which dry nitrogen or dry argon was caused to flow was thereafter used to volatilize the ethanol and dry the mixture of the starting materials. The recovered dry mixture of the starting materials was placed in a lidded alumina crucible and baked for 2 hours at 1,200° C. in a vacuum, hydrogen sulfide gas, hydrogen gas, argon gas, or nitrogen gas to prepare the phosphor. It is apparent that this method for synthesizing a phosphor is merely an example of the synthesizing method for the present invention.

TABLE 2
Composition Table 1

| | ZnS | Ag₂S | NaCl |
|---|---|---|---|
| Composition 1 | 10.0000 | 0.0254 | 0.0060 |

TABLE 3
Composition Table 2

| | ZnS | BeS | Ag₂S | NaCl |
|---|---|---|---|---|
| Composition 2 | 9.7830 | 0.2170 | 0.0262 | 0.0062 |
| Composition 3 | 9.0467 | 0.9533 | 0.0288 | 0.0068 |
| Composition 4 | 8.4700 | 1.5300 | 0.0308 | 0.0073 |
| Composition 5 | 8.1502 | 1.8498 | 0.0319 | 0.0075 |
| Composition 6 | 7.0349 | 2.9651 | 0.0358 | 0.0084 |
| Composition 7 | 6.1266 | 3.8734 | 0.0389 | 0.0092 |

TABLE 4
Composition Table 3

| | ZnS | MgS | Ag₂S | NaCl |
|---|---|---|---|---|
| Composition 8 | 9.7050 | 0.2954 | 0.0260 | 0.0061 |
| Composition 9 | 8.7366 | 1.2634 | 0.0278 | 0.0065 |
| Composition 10 | 8.0135 | 1.9865 | 0.0291 | 0.0069 |
| Composition 11 | 7.6251 | 2.7349 | 0.0298 | 0.0070 |
| Composition 12 | 6.3354 | 3.6646 | 0.0322 | 0.0076 |
| Composition 13 | 5.3544 | 4.6456 | 0.0340 | 0.0080 |

TABLE 5
Composition Table 4

| | ZnS | CaS | Ag₂S | NaCl |
|---|---|---|---|---|
| Composition 14 | 9.6250 | 0.3750 | 0.0258 | 0.0061 |
| Composition 15 | 8.4382 | 1.5618 | 0.0268 | 0.0063 |
| Composition 16 | 7.5914 | 2.4086 | 0.0276 | 0.0065 |
| Composition 17 | 7.1498 | 2.8502 | 0.0280 | 0.0066 |
| Composition 18 | 5.7460 | 4.2540 | 0.0292 | 0.0069 |
| Composition 19 | 4.7382 | 5.2618 | 0.0301 | 0.0071 |

TABLE 6
Composition Table 5

| | ZnS | SrS | Ag₂S | NaCl |
|---|---|---|---|---|
| Composition 20 | 9.3929 | 0.6071 | 0.0251 | 0.0059 |
| Composition 21 | 7.6512 | 2.3488 | 0.0243 | 0.0057 |
| Composition 22 | 6.5514 | 3.4486 | 0.0238 | 0.0056 |
| Composition 23 | 6.0192 | 3.9808 | 0.0235 | 0.0055 |
| Composition 24 | 4.4878 | 5.5122 | 0.0228 | 0.0054 |
| Composition 25 | 3.5182 | 6.4818 | 0.0224 | 0.0053 |

TABLE 7
Composition Table 6

| | ZnS | BaS | Ag₂S | NaCl |
|---|---|---|---|---|
| Composition 26 | 9.1618 | 0.8382 | 0.0245 | 0.0058 |
| Composition 27 | 6.9708 | 3.0292 | 0.0222 | 0.0052 |
| Composition 28 | 5.7308 | 4.2692 | 0.0208 | 0.0049 |
| Composition 29 | 5.1654 | 4.8346 | 0.0202 | 0.0048 |
| Composition 30 | 3.6520 | 6.3480 | 0.0186 | 0.0044 |
| Composition 31 | 2.7721 | 7.2279 | 0.0176 | 0.0042 |

TABLE 8
Composition Table 7

| | ZnS | MgS | Ag₂S | NaCl |
|---|---|---|---|---|
| Composition 32 | 7.6251 | 2.7349 | 0.0298 | 0.0000 |
| Composition 33 | 7.6251 | 2.7349 | 0.0298 | 0.000014 |
| Composition 34 | 7.6251 | 2.7349 | 0.0298 | 0.00014 |
| Composition 35 | 7.6251 | 2.7349 | 0.0298 | 0.0014 |
| Composition 36 | 7.6251 | 2.7349 | 0.0298 | 0.0028 |
| Composition 37 | 7.6251 | 2.7349 | 0.0298 | 0.0042 |
| Composition 38 | 7.6251 | 2.7349 | 0.0298 | 0.0056 |
| Composition 39 | 7.6251 | 2.7349 | 0.0298 | 0.0070 |
| Composition 40 | 7.6251 | 2.7349 | 0.0298 | 0.0084 |
| Composition 41 | 7.6251 | 2.7349 | 0.0298 | 0.0098 |
| Composition 42 | 7.6251 | 2.7349 | 0.0298 | 0.0113 |
| Composition 43 | 7.6251 | 2.7349 | 0.0298 | 0.0127 |
| Composition 44 | 7.6251 | 2.7349 | 0.0298 | 0.0141 |

TABLE 9
Composition Table 8

| | ZnS | MgS | Ag₂S | Co- | Co-activator |
|---|---|---|---|---|---|
| Composition 45 | 7.6251 | 2.7349 | 0.0298 | Al₂S₃ | 0.0090 |
| Composition 46 | 7.6251 | 2.7349 | 0.0298 | Ga₂S₃ | 0.0141 |
| Composition 47 | 7.6251 | 2.7349 | 0.0298 | NaF | 0.0051 |
| Composition 48 | 7.6251 | 2.7349 | 0.0298 | NaBr | 0.0124 |
| Composition 49 | 7.6251 | 2.7349 | 0.0298 | NaI | 0.0180 |

TABLE 10
Composition Table 9

| | ZnS | MgS | Ag₂S | NaCl |
|---|---|---|---|---|
| Composition 50 | 7.6251 | 2.7349 | 0.00015 | 0.00004 |
| Composition 51 | 7.6251 | 2.7349 | 0.00075 | 0.00018 |
| Composition 52 | 7.6251 | 2.7349 | 0.0015 | 0.00035 |
| Composition 53 | 7.6251 | 2.7349 | 0.0075 | 0.0018 |
| Composition 54 | 7.6251 | 2.7349 | 0.0149 | 0.0035 |
| Composition 55 | 7.6251 | 2.7349 | 0.0298 | 0.0070 |
| Composition 56 | 7.6251 | 2.7349 | 0.0746 | 0.0176 |
| Composition 57 | 7.6251 | 2.7349 | 0.1491 | 0.0352 |
| Composition 58 | 7.6251 | 2.7349 | 0.7457 | 0.1759 |
| Composition 59 | 7.6251 | 2.7349 | 1.4914 | 0.3517 |

(Method for Evaluating the Emission Wavelength)

The emission characteristics of the synthesized phosphors were evaluated using PL and CL. PL measurements were carried out using a Hitachi F4500 fluorescence spectrometer, and CL measurements were carried out using a scanning electron microscope manufactured by JASCO. The excitation sources were an Xe lamp and a 10-kV electron beam, respectively. The measurement temperature for the two measurement types was room temperature.

The phosphor of the present invention has two emission peaks that differ in wavelength, and although the tail end of each of the emission peaks extends over about 100 nm, the two emission peaks overlap because they are separated by only about 50 nm. PL and CL spectra have high emission intensities, and an emission spectrum having a low emission intensity is obtained as a shoulder. In relation to peaks having a large emission intensity, the wavelength that shows the maximum value of each of the peaks was used as the emission wavelength. The emission spectra having low emission intensity was separated in the following manner. First, emission spectra having large emission intensity were approximated using a Gaussian function. Next, the Gaussian function with which the emission spectra having a large emission intensity had been approximated was subtracted from the entire spectrum, whereby an emission spectrum that had low emission intensity present as a shoulder was obtained as a single peak, and the wavelength of the maximum value of the single peak was used as the emission wavelength of the low-emission-intensity peak.

Of the resulting two emission spectra, the emission spectrum on the long-wavelength side was taken to be the G-Cu emission, and the emission spectrum on the short-wavelength side was taken to be the B-Cu emission.

(Effect of the ZnS—BeS Mixed Crystal Ratio)

Phosphors were prepared by the previously described procedure from the starting material compositions used in the amounts indicated by composition 1 shown in composition table 1 and compositions 2 to 7 shown in composition table 2. Baking was carried out in nitrogen gas. These compositions contained ZnS and BeS in Zn/Be molar ratios of 100/0, 95/5, 80/20, 70/30, 65/35, 50/50, and 40/60; Ag₂S in an Ag/(Zn+Be) molar ratio of 0.2/100; and NaCl in a Cl/Ag molar ratio of 0.5/1.

TABLE 11 below shows the emission wavelength of G-Cu emissions in PL, the emission wavelength of B-Cu emissions, and the B-Cu/G-Cu emission intensity ratio. A B-Cu emission peak was manifest when the BeS content was 5 mol % or higher, and the B-Cu/G-Cu emission intensity ratio increased as the BeS content was increased. The reason for this is believed to be that the crystal lattice was expanded by a greater amount of BeS, and the interstitial Ag, which forms B-Cu emission sites, was increased. However, the composition having a Zn/Be ratio of 40/60 exhibited emissions at the same wavelength as the composition having a 50/50 ratio. This is thought to be due to the fact that the crystal of a Zn_{0.5}Be_{0.5}S composition is essentially the same as a composition that has a loading concentration of Zn/Be=50/50, because the solid solution limit of BeS in ZnS is reported to be about 50%. The B-Cu/G-Cu emission intensity ratio rapidly increased to double or more when the Be content ratio was greater than Zn/Ba=80/20. Such a situation is preferred because B-Cu emissions having a high emission intensity can be obtained. In CL emissions, the two emission peaks match those of PL emissions, the B-Cu/G-Cu emission intensity ratio is 1 or higher, and the main emissions are B-Cu emissions.

TABLE 11
Table 11 ZnS—BeS mixed crystal phosphor emission wavelengths

| | | | G-Cu | B—Cu | B—Cu/ |
|---|---|---|---|---|---|
| | | | emission | emission | G-Cu |
| | | | wave- | wave- | emission |
| | | Zn/Be | length | length | intensity |
| | Composition | ratio | (nm) | (nm) | ratio |
| Compar- | Composition 1 | 100/0 | 450 | No peak | — |
| ative | | | | | |
| example | | | | | |
| Example | Composition 2 | 95/5 | 430 | 378 | 0.23 |
| Example | Composition 3 | 80/20 | 421 | 371 | 0.54 |
| Example | Composition 4 | 70/30 | 412 | 364 | 0.67 |
| Example | Composition 5 | 65/35 | 405 | 358 | 0.71 |
| Example | Composition 6 | 50/50 | 390 | 343 | 0.65 |
| Example | Composition 7 | 40/60 | 390 | 343 | 0.67 |

(Effect of the ZnS—MgS Mixed Crystal Ratio)

Phosphors were prepared by the previously described procedure from the starting material compositions used in the amounts indicated by composition 1 shown in composition table 1 and compositions 8 to 13 shown in composition table 3. Baking was carried out in nitrogen gas. These compositions contained ZnS and MgS in Zn/Mg molar ratios of 100/0, 95/5, 80/20, 70/30, 65/35, 50/50, and 40/60; Ag₂S in an Ag/(Zn+Mg) molar ratio of 0.2/100; and NaCl in a Cl/Ag molar ratio of 0.5/1.

TABLE 12 below shows the emission wavelength of G-Cu emissions in PL, the emission wavelength of B-Cu emissions, and the B-Cu/G-Cu emission intensity ratio. A B-Cu emission peak was manifest when the MgS content was 5 mol % or higher, and the B-Cu/G-Cu emission intensity ratio increased as the MgS content was increased. The reason for this is believed to be that the crystal lattice was expanded by a greater amount of MgS, and the interstitial Ag, which forms B-Cu emission centers, was increased. However, the composition having a Zn/Mg ratio of 40/60 exhibited emissions at the same wavelength as the composition having a 50/50 ratio. This is thought to be due to the fact that the crystal of a Zn_{0.5}Mg_{0.5}S composition is essentially the same as a composition that has a loading concentration of Zn/Mg=50/50, because the solid solution limit of MgS in ZnS is reported to be about 50%. The B-Cu/G-Cu emission intensity ratio rapidly increased to double or more when the Mg content ratio was greater than Zn/Mg=80/20. Such a situation is preferred because B-Cu emissions having a high emission intensity can be obtained. In CL emissions, the two emission peaks match those of PL emissions, the B-Cu/G-Cu emission intensity ratio is 1 or higher, and the main emissions are B-Cu emissions.

TABLE 12
Table 12 ZnS—MgS mixed crystal phosphor emission wavelengths

| | | | G-Cu | B—Cu | B—Cu/G-Cu |
|---|---|---|---|---|---|
| | | | emission | emission | emission |
| | | Zn/Mg | wavelength | wavelength | intensity |
| | Composition | ratio | (nm) | (nm) | ratio |
| Comparative | Composition 1 | 100/0 | 450 | No peak | — |
| example | | | | | |
| Example | Composition 8 | 95/5 | 430 | 383 | 0.26 |
| Example | Composition 9 | 80/20 | 426 | 379 | 0.58 |
| Example | Composition 10 | 70/30 | 421 | 376 | 0.63 |
| Example | Composition 11 | 65/35 | 415 | 369 | 0.68 |
| Example | Composition 12 | 50/50 | 400 | 350 | 0.65 |
| Example | Composition 13 | 40/60 | 400 | 350 | 0.64 |

(Effect of the ZnS—CaS Mixed Crystal Ratio)

Phosphors were prepared by the previously described procedure from the starting material compositions used in the amounts indicated by composition 1 shown in composition table 1 and compositions 14 to 19 shown in composition table 4. Baking was carried out in nitrogen gas. These compositions contained ZnS and CaS in Zn/Ca molar ratios of 100/0, 95/5, 80/20, 70/30, 65/35, 50/50, and 40/60; Ag₂S in an Ag/(Zn+Ca) molar ratio of 0.2/100; and NaCl in a Cl/Ag molar ratio of 0.5/1.

TABLE 13 below shows the emission wavelength of G-Cu emissions in PL, the emission wavelength of B-Cu emissions, and the B-Cu/G-Cu emission intensity ratio. A B-Cu emission peak was manifest when the CaS content was 5 mol % or higher, and the B-Cu/G-Cu emission intensity ratio increased as the CaS content was increased. The reason for this is believed to be that the crystal lattice was expanded by a greater amount of CaS, and the interstitial Ag, which forms B-Cu emission centers, was increased. However, the composition having a Zn/Ca ratio of 40/60 exhibited emissions at the same wavelength as the composition having a 50/50 ratio. This is thought to be due to the fact that the crystal of a Zn_{0.5}Ca_{0.5}S composition is essentially the same as a composition that has a loading concentration of Zn/Ca=50/50, because the solid solution limit of CaS in ZnS is reported to be about 50%. The B-Cu/G-Cu emission intensity ratio rapidly increased to double or more when the Ca content ratio was greater than Zn/Ca=80/20. Such a situation is preferred because B-Cu emissions having high emission intensity can be obtained. In CL emissions, the two emission peaks match those of PL emissions, the B-Cu/G-Cu emission intensity ratio is 1 or higher, and the main emissions are B-Cu emissions.

TABLE 13
Table 13 ZnS—CaS mixed crystal phosphor emission wavelengths

| | | | G-Cu | B—Cu | B—Cu/G-Cu |
|---|---|---|---|---|---|
| | | | emission | emission | emission |
| | | Zn/Ca | wavelength | wavelength | intensity |
| | Composition | ratio | (nm) | (nm) | ratio |
| Comparative | Composition 1 | 100/0 | 450 | No peak | — |
| example | | | | | |
| Example | Composition 14 | 95/5 | 437 | 385 | 0.21 |
| Example | Composition 15 | 80/20 | 428 | 380 | 0.51 |
| Example | Composition 16 | 70/30 | 424 | 374 | 0.65 |
| Example | Composition 17 | 65/35 | 420 | 371 | 0.61 |
| Example | Composition 18 | 50/50 | 405 | 356 | 0.63 |
| Example | Composition 19 | 40/60 | 405 | 356 | 0.64 |

(Effect of the ZnS—SrS Mixed Crystal Ratio)

Phosphors were prepared by the previously described procedure from the starting material compositions used in the amounts indicated by composition 1 shown in composition table 1 and compositions 20 to 25 shown in composition table 5. Baking was carried out in nitrogen gas. These compositions contained ZnS and SrS in Zn/Sr molar ratios of 100/0, 95/5, 80/20, 70/30, 65/35, 50/50, and 40/60; Ag₂S in an Ag/(Zn+Sr) molar ratio of 0.2/100; and NaCl in a Cl/Ag molar ratio of 0.5/1.

TABLE 14 below shows the emission wavelength of G-Cu emissions in PL, the emission wavelength of B-Cu emissions, and the B-Cu/G-Cu emission intensity ratio. A B-Cu emission peak was manifest when the SrS content was 5 mol % or higher, and the B-Cu/G-Cu emission intensity ratio increased as the SrS content was increased. The reason for this is believed to be that the crystal lattice was expanded by a greater amount of SrS, and the interstitial Ag, which forms B-Cu emission centers, was increased. However, the composition having a Zn/Sr ratio of 40/60 exhibited emissions at the same wavelength as the composition having a 50/50 ratio. This is thought to be due to the fact that the crystal of a Zn_{0.5}Ca_{0.5}S composition is essentially the same as a composition that has a loading concentration of Zn/Sr=50/50, because the solid solution limit of SrS in ZnS is reported to be about 50%. The B-Cu/G-Cu emission intensity ratio rapidly increased to double or more when the Ca content ratio was greater than Zn/Sr=80/20. Such a situation is preferred because B-Cu emissions having high emission intensity can be obtained. In CL emissions, the two emission peaks match those of PL emissions, the B-Cu/G-Cu emission intensity ratio is 1 or higher, and the main emissions are B-Cu emissions.

TABLE 14
Table 14 ZnS—SrS mixed crystal phosphor emission wavelengths

| | | | G-Cu | B—Cu | B—Cu/G-Cu |
|---|---|---|---|---|---|
| | | | emission | emission | emission |
| | | Zn/Sr | wavelength | wavelength | intensity |
| | Composition | ratio | (nm) | (nm) | ratio |
| Comparative | Composition 1 | 100/0 | 450 | No peak | — |
| example | | | | | |
| Example | Composition 20 | 95/5 | 435 | 386 | 0.28 |
| Example | Composition 21 | 80/20 | 430 | 381 | 0.59 |
| Example | Composition 22 | 70/30 | 427 | 376 | 0.71 |
| Example | Composition 23 | 65/35 | 423 | 373 | 0.65 |
| Example | Composition 24 | 50/50 | 408 | 358 | 0.63 |
| Example | Composition 25 | 40/60 | 408 | 358 | 0.61 |

(Effect of the ZnS—BaS Mixed Crystal Ratio)

Phosphors were prepared by the previously described procedure from the starting material compositions used in the amounts indicated by composition 1 shown in composition table 1 and compositions 26 to 31 shown in composition table 6. Baking was carried out in nitrogen gas. These compositions contained ZnS and BaS in Zn/Ba molar ratios of 100/0, 95/5, 80/20, 70/30, 65/35, 50/50, and 40/60; Ag₂S in an Ag/(Zn+Ba) molar ratio of 0.2/100; and NaCl in a Cl/Ag molar ratio of 0.5/1.

TABLE 15 below shows the emission wavelength of G-Cu emissions in PL, the emission wavelength of B-Cu emissions, and the B-Cu/G-Cu emission intensity ratio. A B-Cu emission peak was manifest when the BaS content was 5 mol % or higher, and the B-Cu/G-Cu emission intensity ratio increased as the BaS content was increased. The reason for this is believed to be that the crystal lattice was expanded by a greater amount of BaS, and the interstitial Ag, which forms B-Cu emission centers, was increased. However, the composition having a Zn/Ba ratio of 40/60 exhibited emissions at the same wavelength as the composition having a 50/50 ratio. This is thought to be due to the fact that the crystal of a Zn_{0.5}Ca_{0.5}S composition is essentially the same as a composition that has a loading concentration of Zn/Ba=50/50, because the solid solution limit of BaS in ZnS is reported to be about 50%. The B-Cu/G-Cu emission intensity ratio rapidly increased to double or more when the Ba content ratio was greater than Zn/Ba=80/20. Such a situation is preferred because B-Cu emissions having high emission intensity can be obtained. In CL emissions, the two emission peaks match those of PL emissions, the B-Cu/G-Cu emission intensity ratio is 1 or higher, and the main emissions are B-Cu emissions.

TABLE 15
Table 15 ZnS—BaS mixed crystal phosphor emission wavelengths

| | | | G-Cu | B—Cu | B—Cu/G-Cu |
|---|---|---|---|---|---|
| | | | emission | emission | emission |
| | | Zn/Ba | wavelength | wavelength | intensity |
| | Composition | ratio | (nm) | (nm) | ratio |
| Comparative | Composition 1 | 100/0 | 450 | No peak | — |
| example | | | | | |
| Example | Composition 26 | 95/5 | 440 | 387 | 0.23 |
| Example | Composition 27 | 80/20 | 436 | 385 | 0.56 |
| Example | Composition 28 | 70/30 | 435 | 384 | 0.58 |
| Example | Composition 29 | 65/35 | 434 | 383 | 0.63 |
| Example | Composition 30 | 50/50 | 419 | 368 | 0.61 |
| Example | Composition 31 | 40/60 | 419 | 368 | 0.62 |

(Effect of the Co-Activator Concentration)

Phosphors were prepared by the previously described procedure from the starting material compositions used in the amounts indicated by compositions 32 to 44 shown in composition table 7. Baking was carried out in nitrogen gas. These compositions contained ZnS and MgS in a Zn/Mg molar ratio of 65/35; Ag₂S in an Ag/(Zn+Ba) molar ratio of 0.2/100; and a co-activator and activator in Cl/Ag concentration molar ratios of 0, 0.1, 1, 10, 20, 30, 40, 50, 60, 70, 80, 90, and 100%.

TABLE 16 below shows the B-Cu/G-Cu emission intensity ratio in the PL of the prepared phosphor. When the co-activator Cl/activator Ag concentration molar ratios were 0 and 0.1 to 90%, B-Cu emissions were obtained, but B-Cu emissions were not obtained when the concentration molar ratio was 100%. The reason that B-Cu emissions were not obtained when the co-activator Cl/activator Ag concentration ratio was 100% is that the Ag activator and co-activator Cl concentrations were equal. Therefore, the Ag activator was entirely charge compensated by the Cl, was substituted into the Zn lattice positions, and could not enter the interstices. When the co-activator Cl/activator Ag molar concentration ratio was 0 to 60%, the B-Cu/G-Cu emission intensity ratio rapidly increased to double or more in comparison with when the molar concentration ratio was 70 to 90%. Such a situation is preferred because B-Cu emissions having high emission intensity can be obtained. The phosphor of the composition marked with an asterisk in TABLE 16 is a comparative example.

TABLE 16
Table 16: Relationship between the co-activator concentration and the
B—Cu/G-Cu emission intensity ratio

| | Co-activator/activator molar | B—Cu/G-Cu emission |
|---|---|---|
| | concentration ratio (%) | intensity ratio |
| *Composition 32 | 0 | 0.47 |
| Composition 33 | 0.1 | 0.50 |
| Composition 34 | 1 | 0.53 |
| Composition 35 | 10 | 0.49 |
| Composition 36 | 20 | 0.52 |
| Composition 37 | 30 | 0.63 |
| Composition 38 | 40 | 0.58 |
| Composition 39 | 50 | 0.68 |
| Composition 40 | 60 | 0.51 |
| Composition 41 | 70 | 0.21 |
| Composition 42 | 80 | 0.23 |
| Composition 43 | 90 | 0.22 |
| Composition 44 | 100 | No B—Cu emission peak |

(Effect of the Co-Activator Type)

Phosphors were prepared by the previously described procedure from the starting material compositions used in the amounts indicated by compositions 45 to 49 shown in composition table 8. Baking was carried out in nitrogen gas. These compositions contained ZnS and MgS in a Zn/Mg molar ratio of 65/35; Ag₂S in an Ag/(Zn+Mg) molar ratio of 0.2/100; and at least one compound selected from among Al₂S₃, Ga₂S₃, NaF, NaBr, and NaI so that the co-activator/activator Ag concentration molar ratio was 50%. In addition to the G-Cu emission intensity, a B-Cu emission having an intensity of 20% or more with respect to the G-Cu emission intensity was obtained in the same manner as when the Cl was used as the co-activator was for all phosphors to which a co-activator was added.

(Effect of the α-Phase Content Ratio)

Phosphors having the starting material composition indicated by composition 10 in composition table 3 were baked and then rapidly cooled. A PL measurement of the phosphors in which the α-phase content ratio was varied was performed. The crystal phase was measured using XRD analysis, and the ratio H (%) of the α-phase with respect to the entire crystal phase was calculated from the following Steward formula.

$$H ( \% ) = 1.69 \times \frac{B}{A + 0.69 \times B} \times 100 \qquad [ EQ . 1 ]$$

In the formula, A and B are XRD intensities 28.5° and 51.8°, respectively.

TABLE 17 below shows the B-Cu/G-Cu emission intensity ratios when the α-phase content ratio was 40 to 100%. A clear B-Cu emission peak was not obtained for the sample that had an a-phase content of 40%. A B-Cu emission peak was obtained for the samples that had an α-phase content of 50% or higher. This is believed to due to the fact that the amount of activator Ag that entered the interstices was increased by a higher α-phase content, which has a larger lattice constant. When the α-phase content was 80% or higher, the B-Cu/G-Cu emission intensity ratio rapidly increased to double or more of that of the samples having an α-phase content of less than 80%. Such a situation is preferred because B-Cu emissions having high emission intensity can be obtained.

TABLE 17
Table 17: Relationship between the α-phase content ratio and the
B—Cu/G-Cu emission intensity ratio

| | B—Cu/G-Cu emission intensity |
|---|---|
| α-Phase content ratio (%) | ratio |
| *40 | No B—Cu emission peak |
| 50 | 0.21 |
| 60 | 0.29 |
| 70 | 0.32 |
| 80 | 0.65 |
| 90 | 0.71 |
| 100 | 0.68 |

(Effect of the Activator Concentration)

TABLE 18 below shows the relationship between the Ag activator concentration and the B-Cu/G-Cu emission intensity ratio of phosphors prepared using compositions 50 to 59 of composition table 9, wherein the phosphor matrix comprises ZnS and MgS in a Zn/Mg molar ratio of 65/35, the concentration of the Ag activator is 0.001 to 5 mol % of the metal elements of the phosphor matrix, and the concentration of the co-activator Cl is 50 mol % of that of the Ag activator. A B-Cu emission peak was not obtained for compositions in which the activator was 0.001 mol % and 10.0 mol %. B-Cu emission peaks were obtained for compositions in which the Ag activator was from 0.005 to 5 mol % of the metal elements of the phosphor matrix. For concentrations of 0.2 to 1 mol % in particular, the B-Cu/G-Cu emission intensity ratio rapidly increased to double or more of the compositions in which concentration was less than 0.2 mol % or 5 mol % or higher. Such a situation is preferred because B-Cu emissions having high emission intensity can be obtained. The phosphor of the composition marked with an asterisk in TABLE 18 is a comparative example.

TABLE 18
Table 18: Relationship between the Ag activator concentration and the
B—Cu/G-Cu emission intensity ratio

| | Activator Ag concentration | B—Cu/G-Cu emission |
|---|---|---|
| | (mol %) | intensity ratio |
| *Composition 50 | 0.001 | No B—Cu emission peak |
| Composition 51 | 0.005 | 0.24 |
| Composition 52 | 0.01 | 0.27 |
| Composition 53 | 0.05 | 0.30 |
| Composition 54 | 0.1 | 0.32 |
| Composition 55 | 0.2 | 0.68 |
| Composition 56 | 0.5 | 0.71 |
| Composition 57 | 1.0 | 0.76 |
| Composition 58 | 5.0 | 0.34 |
| *Composition 59 | 10.0 | No B—Cu emission peak |

(Effect of the Baking Atmosphere)

TABLE 19 below shows the relationship between the B-Cu/G-Cu emission intensity ratio and each of the baking atmospheres used for the phosphors prepared using the starting materials indicated by composition 11 in composition table 3. The phosphors were baked at 1,200° C. in a vacuum, hydrogen sulfide gas, hydrogen gas, argon gas, or nitrogen gas. B-Cu emissions were not obtained by baking in a vacuum, but the phosphors baked in hydrogen sulfide gas, hydrogen gas, argon gas, or nitrogen gas demonstrated intense B-Cu emissions that exceeded 20% of G-Cu emission intensity. For phosphors baked in hydrogen, argon, and nitrogen gases in particular, the B-Cu/G-Cu emission intensity ratio rapidly increased to double or more in comparison with baking in hydrogen sulfide gas. Such a situation is preferred because B-Cu emissions having high emission intensity can be obtained.

TABLE 19
Table 19: Relationship between the baking atmosphere and the
B—Cu/G-Cu emission intensity ratio

| | | B—Cu/G-Cu emission |
|---|---|---|
| | Baking atmosphere | intensity ratio |
| Comparative | Vacuum | No B—Cu emission peak |
| example | | |
| Example | Hydrogen sulfide | 0.26 |
| Example | Hydrogen | 0.57 |
| Example | Argon | 0.63 |
| Example | Nitrogen | 0.68 |

(Effect of Annealing)

The emission intensities of a rapidly cooled Ag-activated Zn₍₁₋ₓ₎AₓS phosphor and an Ag-activated Zn₍₁₋ₓ₎AₓS phosphor annealed for 8 hours at 300° C. in nitrogen gas were compared in order to study the effect that annealing after baking has on the emission characteristics. The annealed and unannealed phosphors were compared, and B-Cu and G-Cu emissions were found to increase in intensity by a magnitude of about 1.6. The reason for this is thought to be that Ag that had entered the interstices was not ejected by annealing at low temperature, and only crystal strain introduced by rapid cooling was eliminated.

(Effect of the Solvent of the Starting Material Mixture)

The emission wavelengths of phosphors prepared by mixing, drying in nitrogen, and baking the starting material powders indicated by composition 11 in composition table 3 were studied in relation to the solvents water and ethanol in order to study the effect of the solvent used for mixing the starting materials. TABLE 20 below shows the G-Cu emission wavelength, B-Cu emission wavelength, and B-Cu/G-Cu emission intensity ratio for each of the mixing solvents. B-Cu emissions were obtained for the phosphor in which the starting materials were mixed in ethanol, but a B-Cu emission was not obtained for the phosphor mixed in water. This is believed to be due to the fact that ZnS and MgS were essentially not formed into a mixed crystal because the wavelength of the G-Cu emission was substantially not reduced in comparison with ZnS alone. The reason for this is thought to be that since Group 2A sulfides are chemically unstable and hydrolyze in contact with water, most of the MgS in the mixture decomposed. For this reason, the starting material mixture of ZnS and Group 2A sulfides according to the present invention is preferably mixed in ethanol or another organic solvent in which Group 2A sulfides do not decompose.

TABLE 20
Table 20: Emission wavelength of each mixing solvent

| | | G-Cu | | |
|---|---|---|---|---|
| | | emission | B—Cu emission | B—Cu/G-Cu |
| | | wavelength | wavelength | emission |
| | Solvent | (nm) | (nm) | intensity ratio |
| Comparative | Water | 447 | No peak | — |
| example | | | | |
| Example | Ethanol | 415 | 369 | 0.68 |

### EXAMPLE 3

Ag and Au were used as activators in the present example.

(Method for Preparing a Phosphor)

(1) Starting Material

Phosphor matrices: ZnS, MgS, CaS, SrS, and BeS having a mean grain size of 1 μm

Activators:
(a) Ag source: Ag₂S powder having a mean grain size of 1 μm
(b) Au sources: AuCl₃ powder having a mean grain size of 10 μm, and Au powder having a mean grain size of 40 μm.

Co-activators: Same AuCl₃ as the one above (shared with the activator), and NaCl powder having a mean grain size of 20 μm

(2) Mixing

The starting material powders having prescribed doped compositions were dispersed in various solvents and mixed for 3 hours by applying ultrasonic vibrations. The solvents were volatilized and the starting material mixtures were dried using an evaporator in which dry argon was allowed to flow.

(3) Baking

The recovered starting material mixtures were placed in a 20×200×20 mm (height) lidded alumina crucibles, and baked for 6 hours at prescribed temperatures in prescribed gases at a pressure of 1 atmosphere by using a tube furnace. A 300×300×100 mm (height) container having a thickness of 0.5 mm was floated on water held in another container. The samples were left in the crucibles and the crucibles were removed in a group from the baking temperature, turned upside down, and transferred to the container floating on water and cooled.

(4) Introducing Strain

The baked samples were loaded into a press molding machine and pressed at a surface pressure of 50 MPa, and the molded product was thereafter pulverized using a ball mill to return the samples to a powder.

(5) Annealing

Some of the cooled samples were annealed for 2.5 hours at prescribed temperatures in argon gas. Unannealed samples were also prepared.

(6) Etching

100 cc of ammonia water was added per 4 g of phosphors in order to remove the Au present on the surface of the phosphor, 30 cc of hydrogen peroxide water was added, the components were allowed to stand for one hour, and the turbid fluid was then discarded. The step was repeated three times until the fluid became transparent. Next, the samples were washed five times using 1,000 cc of purified water per 4 g of phosphor.

(Method for Evaluating Emission Wavelength)

Concavities measuring 40×40×50 (depth) μm were formed in 50×50×1 mm quartz glass substrates, and aluminum was vapor deposited to a thickness of 0.1 μm to form a back electrode. The phosphors were mixed with castor oil using ultrasonic waves in a volume fraction of 35 vol % to form slurries, and the slurries were poured into the cavities. Lastly, an EL device was obtained by using a cover formed from a 50×50×1 mm quartz glass substrate on which a transparent electroconductive film (surface electrode) was coated to a thickness of 0.1 μm.

Lead wires were mounted on the two electrodes, and an AC voltage having a frequency of 3,000 Hz and a voltage of 500 V was applied. The emission spectra were measured using a photonic analyzer at the same sensitivity. The peak wavelengths of the resulting emission spectra were compared with each other (Nos. 34 to 43 and Nos. 47 to 52).

The results are shown in TABLE 21 below. In TABLE 21, the second component is a sulfide of the element expressed by A in the general formula of the present invention, and the content of the second component expressed in mol % is a value that corresponds to the variable x in the general formula. The Ag concentration, Au concentration, and co-activator concentration are expressed in mol % with respect to the metal elements (Zn and Mg, in the case of No. 28) of the phosphor matrix. Nos. 28 and 34 do not contain Au, and Nos. 29 and 53 show G-Cu emissions.

TABLE 21
Table 21

| | | | | | | | | | Activator | |
|---|---|---|---|---|---|---|---|---|---|---|
| | | | Second | | | | Ag | Au | (Ag + Au) | Ag/ |
| | | Second | component | First | Second | Co- | concentration | concentration | concentration | (Ag + Au) |
| No. | Material | component | content (mol %) | activator | activator | activator | (mol %) | (mol %) | (mol %) | mol % |
| *28 | ZnS | MgS | 0 | Ag | none | Cl | 0.4 | 0 | 0.4 | 100 |
| *29 | ZnS | MgS | 0 | Ag | Au | Cl | 0.4 | 0.3 | 0.7 | 57 |
| 30 | ZnS | MgS | 0 | Ag | Au | Cl | 0.4 | 0.3 | 0.7 | 57 |
| 31 | ZnS | MgS | 0 | Ag | Au | Cl | 0.4 | 0.3 | 0.7 | 57 |
| 32 | ZnS | MgS | 0 | Ag | Au | Cl | 0.4 | 0.3 | 0.7 | 57 |
| 33 | ZnS | MgS | 10 | Ag | Au | Cl | 0.4 | 0.3 | 0.7 | 57 |
| *34 | ZnS | MgS | 20 | Ag | Au | Cl | 0.4 | 0 | 0.4 | 100 |
| 35 | ZnS | MgS | 20 | Ag | Au | Cl | 0.4 | 0.3 | 0.7 | 57 |
| 36 | ZnS | MgS | 20 | Ag | Au | Cl | 0.4 | 0.3 | 0.7 | 57 |
| 37 | ZnS | MgS | 20 | Ag | Au | Cl | 0.4 | 0.3 | 0.7 | 57 |
| 38 | ZnS | MgS | 20 | Ag | Au | Cl | 0.015 | 0.01 | 0.023 | 65 |
| 39 | ZnS | MgS | 20 | Ag | Au | Cl | 0.005 | 0.004 | 0.009 | 56 |
| 40 | ZnS | MgS | 20 | Ag | Au | Cl | 0.48 | 0.6 | 1.08 | 44 |
| 41 | ZnS | MgS | 20 | Ag | Au | Cl | 0.6 | 0.38 | 0.98 | 61 |
| 42 | ZnS | MgS | 20 | Ag | Au | Cl | 1.0 | 0.3 | 1.3 | 77 |
| 43 | ZnS | Mgs | 20 | Ag | Au | Cl | 1.0 | 0.3 | 1.3 | 77 |
| 44 | ZnS | CaS | 30 | Ag | Au | Cl | 0.4 | 0.3 | 0.7 | 57 |
| 45 | ZnS | CaS | 30 | Ag | Au | Cl | 0.4 | 0.3 | 0.7 | 57 |
| 46 | ZnS | SrS | 40 | Ag | Au | Cl | 0.4 | 0.3 | 0.7 | 57 |
| 47 | ZnS | BeS | 50 | Ag | Au | Cl | 0.4 | 0.3 | 0.7 | 57 |
| 48 | ZnS | BeS | 50 | Ag | Au | Cl | 0.4 | 0.3 | 0.7 | 57 |
| 49 | ZnS | BeS | 50 | Ag | Au | Cl | 0.4 | 0.3 | 0.7 | 57 |
| 50 | ZnS | BeS | 50 | Ag | Au | Cl | 0.4 | 0.3 | 0.7 | 57 |
| 51 | ZnS | BeS | 50 | Ag | Au | Cl | 0.4 | 0.3 | 0.7 | 57 |
| 52 | ZnS | BeS | 50 | Ag | Au | Cl | 0.4 | 0.3 | 0.7 | 57 |
| *53 | ZnS | MgS | 0 | Ag | Au | Cl | 0.8 | 0.1 | 0.9 | 89 |

| | | | Co- | | | | | | Annealing | EL emission | Relative |
|---|---|---|---|---|---|---|---|---|---|---|---|
| | Co-activator | Co- | activator/ | Starting | Baking | Baking | | Intro. | tempera- | peak | intensity of |
| | concentration | activator/Ag | (Ag + Au) | material | temperature | envi- | | of | ture | wavelength | peak |
| No. | (mol %) | (mol %) | (mol %) | mixture | (° C.) | ronment | Cooling | strain | (° C.) | (nm) | wavelength |
| *28 | 0.2 | 50 | 50 | Ethanol | 1,000 | Ar | In-oven cooling | Yes | 700 | None | Untested |
| *29 | 0.7 | 175 | 100 | Ethanol | 1,000 | Ar | In-oven cooling | Yes | 700 | 495 | Untested |
| 30 | 0.53 | 133 | 76 | Ethanol | 1,000 | Ar | In-oven cooling | Yes | 700 | 418 | Untested |
| 31 | 0.3 | 75 | 43 | Ethanol | 1,000 | Ar | In-oven cooling | Yes | 700 | 402 | Untested |
| 32 | 0.22 | 55 | 31 | Ethanol | 1,000 | Ar | In-oven cooling | Yes | 700 | 399 | Untested |
| 33 | 0.22 | 55 | 31 | Ethanol | 1,000 | Ar | In-oven cooling | Yes | 700 | 389 | Untested |
| *34 | 0.22 | 55 | 55 | Ethanol | 1,000 | Ar | In-oven cooling | Yes | 700 | None | 0 |
| 35 | 0.22 | 55 | 31 | Ethanol | 1,000 | Ar | In-oven cooling | Yes | 700 | 379 | 100 |
| 36 | 0.22 | 55 | 31 | Ethanol | 1,000 | H2S | In-oven cooling | Yes | 700 | 379 | 115 |
| 37 | 0.22 | 55 | 31 | Ethanol | 1,000 | N2 | In-oven cooling | Yes | 700 | 379 | 82 |
| 38 | 0.01 | 67 | 43 | Ethanol | 1,000 | Ar | In-oven cooling | Yes | 700 | 382 | 33 |
| 39 | 0.005 | 100 | 56 | Ethanol | 1,000 | Ar | In-oven cooling | Yes | 700 | None | 0 |
| 40 | 0.22 | 46 | 20 | Ethanol | 1,000 | Ar | In-oven cooling | Yes | 700 | 379 | 99 |
| 41 | 0.22 | 37 | 22 | Ethanol | 1,000 | Ar | In-oven cooling | Yes | 700 | 379 | 101 |
| 42 | 0.001 | 0.10 | 0.08 | Ethanol | 1,000 | Ar | In-oven cooling | Yes | 700 | 382 | 13 |
| 43 | 0.0008 | 0.08 | 0.06 | Ethanol | 1,000 | Ar | In-oven cooling | Yes | 700 | 381 | 3 |
| 44 | 0.22 | 55 | 31 | Purified | 1,020 | H2 | Rapid cooling in | No | 700 | 389 | Untested |
| | | | | water | | | water | | | | |
| 45 | 0.22 | 55 | 31 | Ethanol | 1,020 | H2 | Rapid cooling in | No | 700 | 373 | Untested |
| | | | | | | | water | | | | |
| 46 | 0.22 | 55 | 31 | Ethanol | 1,100 | H2 | Rapid cooling in | No | 700 | 370 | Untested |
| | | | | | | | water | | | | |
| 47 | 0.22 | 55 | 31 | Ethanol | 1,200 | H2 | Rapid cooling in | No | 700 | 328 | 70 |
| | | | | | | | water | | | | |
| 48 | 0.22 | 55 | 31 | Ethanol | 1,200 | H2 | Rapid cooling in | Yes | 700 | 328 | 118 |
| | | | | | | | water | | | | |
| 49 | 0.22 | 55 | 31 | Ethanol | 1,200 | H2 | In-oven cooling | Yes | 700 | 377 | 100 |
| 50 | 0.22 | 55 | 31 | Ethanol | 1,200 | H2 | In-oven cooling | Yes | 820 | 382 | 78 |
| 51 | 0.22 | 55 | 31 | Ethanol | 1,200 | H2 | Rapid cooling in | No | No | 328 | 3 |
| | | | | | | | water | | | | |
| 52 | 0.5 | 125 | 71 | Ethanol | 1,200 | H2 | Rapid cooling in | No | 700 | 328 | 35 |
| | | | | | | | water | | | | |
| *53 | 0.9 | 113 | 100 | Ethanol | 1,000 | Ar | In-oven cooling | Yes | 700 | 459 | Untested |

EL emissions did not occur when Au was not doped (Nos. 28 and 34). The emission spectrum shifted to the short-wavelength side as the amount of MgS increased (Nos. 44 to 50). The emission wavelength of samples mixed in a water solvent shifted to the long-wavelength side (No. 44). This is believed to be due to the fact that the MgS oxidized prior to baking, and the solid solution content of the Mg in the ZnS was reduced. The emission intensity was reduced (Nos. 49 and 50) when baking was carried out in an N₂ atmosphere (No. 37) and when annealing was not carried out. When baking was carried out in H₂S, the emission intensity was increased (No. 36). When rapid cooling was not used, the emission wavelength shifted to the long-wavelength side (No. 48). This is thought to be due to a reduction in the Be content of the solid solution. EL emissions were observed when the activator concentration was 0.001 mol % or less, but did not have strong relative intensity that was sufficient to allow a peak wavelength to be specified (No. 39). This is possibly due to a low quantity of Au present as an electroconductive phase because the amount of doped activator was low. When the activator concentration exceeded 1 mol %, the emission intensity reached saturation (No. 40). When the Ag concentration exceeded 0.5 mol %, the emission intensity reached saturation (No. 41). When the concentration of co-activator with respect to the activator exceeded 60 mol %, the emission intensity was reduced (No. 50). When the concentration of co-activator with respect to Ag exceeded 60 mol %, the emission intensity was reduced (No. 38). When the concentration of co-activator with respect to the activator exceeded 100 mol %, the sample (No. 53) in which the Ag concentration was sufficiently greater than the Au concentration produced a G-Cu emission having a shorter wavelength than No. 29, which also produced a G-Cu emission.

### EXAMPLE 4

A fluorescent lamp having the structure shown in FIG. 2 was fabricated using Zn_{0.65}Mg_{0.35}S:Ag, Cl particles having a mean grain size of 5 μm as the phosphor. The distance between the grid electrode and the cathode surface was 0.2 mm.

First, 0 to 30 vol % (with respect to the entire amount of powder) of In₂O₃ powder was added to the phosphor and ultrasonically mixed in ethanol. The slurries were coated on one surface of a quartz glass substrate by screen printing and then dried to form a phosphor layer to a thickness of about 15 μm. Next, commercially available CRT phosphor powders indicated in (1) to (3) below were coated and formed to a thickness of 15 μm by screen printing on the other side of the quartz glass substrate. Samples were also fabricated without using the above procedure, and a UV-emitting phosphor layer was formed on only one side.

(1) ZnS:Ag, Cl (blue)

(2) ZnS:Cu, Al (green)

(3) Y₂O₃S:Eu (red)

A metal back layer (Al) was thereafter formed to a thickness of about 100 nm on the surface of the UV-emitting phosphor layer by vacuum deposition. All of the components were assembled using an inorganic adhesive, and the interior of the container was evacuated and sealed. A getter was flashed to absorb residual gases, the interior of the container was set to a pressure of 10⁻⁶ Pa, and prescribed stabilizing procedures were carried out. At this point, the UV-emitting phosphor layer assembly was placed inside the lamp.

First, an anodic current was confirmed to be 200 μA, which was the electric current used when the grid voltage was set to 290 V. The spectrum of the UV rays that passed through the glass substrate was measured using a spectroscope when a voltage of 11 kV was applied to the phosphor surface on which a UV-emitting phosphor layer was formed on only one side (inner side). Next, the brightness of each of the colors was measured using a spectroscope when a lamp, in which a UV-emitting phosphor layer was formed on one side (inner side) and a visible light-emitting layer was formed on the other side (outer side), was caused to emit light under the same conditions.

Excluding the intensity of the UV rays, the brightness in the present example was the brightness of visible light in the wavelength region of 400 to 700 nm. In the present invention, sample Nos. 2, 14, 19, and 22 were described in each example by using a reference brightness of 100.

For comparison, a phosphor was prepared as a UV-emitting phosphor using commercially available ZnO powder having a mean grain size of 5 μm that was baked at 800° C. for 2 hours in an atmosphere comprising 40% oxygen and 80% nitrogen, and the measurements were carried out in the same manner.

Results

The results are shown in TABLE 22 below. The asterisk in TABLE 22 indicates a comparative example.

The fluorescent lamp of the present invention demonstrated high visible light brightness. This is because intense UV rays were produced from the UV-emitting phosphor, and the visible light-emitting phosphors were excited. On the other hand, visible light brightness was very weak in the comparative example. The reason for this is believed to be that the intensity of the UV-emitting phosphor was low and the visible light-emitting phosphors could not be efficiently excited by 385-nm UV rays.

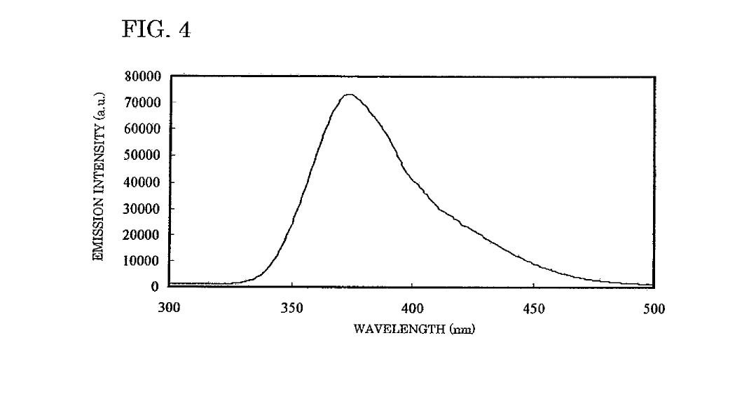

FIG. 4 is a CL spectrogram of sample No. 54. The 369-nm peak showed a B-Cu emission. The reason that the tail end extends to a great length on the long-wavelength side is thought to be that the B-Cu emission in the vicinity of 420 nm was manifest. Thus, it is apparent that an intense B-Cu emission is excited when the present phosphor is excited by an electron beam.

TABLE 22

| | | | Emission | |
|---|---|---|---|---|
| | | | peak | |
| | | | wavelength | Relative |
| No. | UV phosphor | VL phosphor | (nm) | brightness |
| 54 | Zn_{0.65}Mg_{0.35}S: | None | 369 | — |
| | Ag, Cl | | | |
| 55 | Zn_{0.65}Mg_{0.35}S: | ZnS: Ag, Cl (blue) | 450 | 100 |
| | Ag, Cl | | | |
| 56 | Zn_{0.65}Mg_{0.35}S: | ZnS: Cu, Al (green) | 526 | 400 |
| | Ag, Cl | | | |
| 57 | Zn_{0.65}Mg_{0.35}S: | Y₂O₃S: Eu (red) | 611 | 160 |
| | Ag, Cl | | | |
| *58 | ZnO | None | 385 | — |
| *59 | ZnO | ZnS: Ag, Cl (blue) | 450 | 7.2 |
| *60 | ZnO | ZnS: Cu, Al (green) | 526 | 51 |
| *61 | ZnO | Y₂O₃S: Eu (red) | 611 | 10 |

Note:
UV: Ultraviolet rays
VL: Visible light

### EXAMPLE 5

Phosphors having a mean grain size of 5 μm were used as the UV-emitting phosphors, and measurements were performed in the same manner as example 4. The results are shown in TABLE 23 below.

TABLE 23
Table 23

| | | | Emission | |
|---|---|---|---|---|
| | | | peak | |
| | | | wavelength | Relative |
| No. | UV phosphor | VL phosphor | (nm) | brightness |
| 62 | Zn_{0.65}Mg_{0.35}S: Ag, Al | None | 369 | — |
| 63 | Zn_{0.58}Mg_{0.42}S: Ag, Al | None | 362 | — |
| 64 | Zn_{0.72}Mg_{0.28}S: Ag, Al | None | 375 | — |
| 65 | Zn_{0.85}Mg_{0.15}S: Ag, Al | None | 388 | — |
| 66 | Zn_{0.97}Mg_{0.03}S: Ag, Al | None | 399 | — |
| 67 | Zn_{0.65}Mg_{0.35}S: Ag, Al | ZnS: Ag, | 450 | 100 |
| | | Cl (blue) | | |
| 68 | Zn_{0.58}Mg_{0.42}S: Ag, Al | ZnS: Ag, | 450 | 120 |
| | | Cl (blue) | | |
| 69 | Zn_{0.72}Mg_{0.28}S: Ag, Al | ZnS: Ag, | 450 | 88 |
| | | Cl (blue) | | |
| 70 | Zn_{0.97}Mg_{0.03}S: Ag, Al | ZnS: Ag, | 450 | 23 |
| | | Cl (blue) | | |

Higher visible light brightness was demonstrated as the emission wavelength was reduced.

### EXAMPLE 6

The UV-emitting phosphors were samples in which In₂O₃ particles having a mean grain size of 10 nm were deposited in prescribed volume percentages of the phosphor on the surface of Zn_{0.65}Mg_{0.35}S:Ag, Al having a mean grain size of 5 μm. A common hot cathode fluorescent display tube was fabricated and 50 V were applied as the anode voltage to measure the brightness. A visible light-emitting phosphor was coated on the outer surface of the fluorescent display tube in the same manner as example 4, and the brightness was measured. The results are shown in TABLE 24 below.

TABLE 24
Table 24

| | | In₂O₃ | | Relative |
|---|---|---|---|---|
| No. | UV phosphor | (vol %) | VL phosphor | brightness |
| 71 | Zn_{0.65}Mg_{0.35}S: Ag, Al | 0 | ZnS: Ag, Cl (blue) | No |
| | | | | emissions |
| 72 | Zn_{0.65}Mg_{0.35}S: Ag, Al | 10 | ZnS: Ag, Cl (blue) | 100 |
| 73 | Zn_{0.65}Mg_{0.35}S: Ag, Al | 30 | ZnS: Ag, Cl (blue) | 550 |

Visible light was produced because UV rays were generated by compounding In₂O₃, even when low-acceleration electron beam irradiation was used.

### EXAMPLE 7

The UV-emitting phosphors were samples in which Cu₂S particles having a mean grain size of 10 nm were deposited in prescribed volume percentages of the phosphor on the surface of Zn_{0.65}Mg_{0.35}S:Ag, Al having a mean grain size of 5 μm. A common hot cathode fluorescent display tube was fabricated and 35 V were applied as the anode voltage to measure the brightness. A visible light-emitting phosphor was coated on the outer surface of the fluorescent display tube in the same manner as example 4, and the brightness was measured. The results are shown in TABLE 25 below.

TABLE 25
Table 25

| | | Cu₂S | | Relative |
|---|---|---|---|---|
| No. | UV phosphor | (vol %) | VL phosphor | brightness |
| 74 | Zn_{0.65}Mg_{0.35}S: Ag, Al | 0 | ZnS: Ag, Cl (blue) | No |
| | | | | emissions |
| 75 | Zn_{0.65}Mg_{0.35}S: Ag, Al | 15 | ZnS: Ag, Cl (blue) | 100 |
| 76 | Zn_{0.65}Mg_{0.35}S: Ag, Al | 35 | ZnS: Ag, Cl (blue) | 550 |

Visible light was produced because UV rays were generated by compounding Cu₂S, even when low-acceleration electron beam irradiation was used. The relative brightness of examples 4 to 7 show a comparison within each of the examples.

### EXAMPLE 8

A surface-emitting device was fabricated in the present example.

### 1. Preparation

(Resin Sheets)

UV-ray transparent resins sheets (#000 manufactured by Mitsubishi Rayon) measuring 100×100 mm and having a thickness of 100 μm were prepared.

Insulation layerBaTiO₃: mean grain size of 0.2 μm
Resin: Manufactured by Shin-Etsu Chemical (Trade name: Cyano Resin)
First phosphor EL phosphor

| | |
|---|---|
| ZnS: Cu, Cl powder | mean grain size: 3 μm |
| ZnS: Cu, Cl, Al powder | mean grain size: 3 μm |
| ZnS: Ag, Cl powder | mean grain size: 3 μm |
| ZnS-35 mol % MgS: Ag, Cl powder | mean grain size: 3 μm |
| ZnS-35 mol % MgS: Cu, Cl powder | mean grain size: 3 μm |

Phosphors coated with Cu₂S on the surface were used for ZnS: Ag, Cl and Zns-20 mol % MgS: Ag, Cl.

Second phosphor

| | | |
|---|---|---|
| ZnS: Ag, Cl powder | non-persistent | mean grain size: 3 μm |
| ZnS: Cu, Cl powder | persistent | mean grain size: 3 μm |
| SrAl₂O₄: Eu, Dy powder | persistent | mean grain size: 3 μm |
| CaAl₂O₄: Eu, Nd powder | persistent | mean grain size: 3 μm |
| BaAl₂O₄: Eu, Lu powder | persistent | mean grain size: 3 μm |

### 2. Steps

### (1) Formation of a Back Surface Electrode

An Al film was coated to a thickness of 0.4 μm by sputtering on a resin sheet, and electrode lead wires were then bonded to the Al electrode film.

### (2) Formation of an Insulation Layer

Resin was dispersed and dissolved in cyclohexanone to a concentration 25 vol %. BaTiO₃ powder was then dispersed (25 vol %) to form a slurry. The slurry was used to form a coating layer to a thickness of 30 μm by screen printing on the Al electrode of (1).

### (3) Formation of a Light-Emitting Layer

Resin was dispersed and dissolved in cyclohexanone to a concentration of 25 vol % to prepare a sample. A phosphor powder (a powder in which the first and second phosphors were mixed in prescribed compositions) was dispersed (25 vol %) in this solvent in argon gas to form a slurry. The slurry was used to form a coating layer to a thickness of 60 μm by screen printing on the surface of the insulation layer. All of the phosphors were stored in darkness for 24 hours prior to treatment, and were then removed and used.

### (4) Formation of a Surface Electrode and Sealing

A transparent electroconductive film (ITO film) was coated by sputtering to a thickness of 0.2 μm on a resin sheet, and electrode lead wires were then bonded to the Al electrode film. The ITO electrode side of this sheet and the light-emitting layer were superimposed, bonded under heat and pressure, and sealed at 120° C. to obtain a surface-emitting device.

### 3. Evaluation

### (1) Preliminary Evaluation

A surface-emitting device was fabricated using only the first phosphor, and an AC electric field of 200 V and 800 Hz was applied between the electrodes. The emission wavelength (EL emission wavelength) was measured using a multi-photonic analyzer (manufactured by Hamamatsu Photonics). A surface-emitting device was fabricated using only the second phosphor, and an AC electric field of 200 V and 800 Hz was applied between the electrodes. However, the device did not emit light. A commercially available black light having a wavelength of 360 nm was used to irradiate the second phosphor, and the PL emission was measured.

### (2) Evaluation of the Surface-Emitting Devices

An AC electric field of 200 V and 800 Hz was applied between the electrodes of the fabricated surface-emitting devices. The emission intensities were measured using a luminance meter (Minolta). Application of an electric field was then stopped, and the time until the limit (0.3 mcd/m²) of viewable brightness was reached even in darkness was measured. The results are shown in TABLE 26.

TABLE 26
Table 26

| | | Second | | Content of | Content of |
|---|---|---|---|---|---|
| | First phosphor (1) | phosphor type | Second phosphor (2) | (1) (vol %) | (2) (vol %) |
| 77 | ZnS: Cu, Cl | Persistent | SrAl₂O₄: Eu, Dy | 50 | 50 |
| 78 | ZnS: Cu, Cl, Al | Persistent | SrAl₂O₄: Eu, Dy | 50 | 50 |
| 79 | ZnS: Ag, Cl | Persistent | SrAl₂O₄: Eu, Dy | 50 | 50 |
| 80 | Zn_{0.65}Mg_{0.35}S: Cu, Cl | Persistent | SrAl₂O₄: Eu, Dy | 50 | 50 |
| 81 | Zn_{0.65}Mg_{0.35}S: Ag, Cl | Persistent | SrAl₂O₄: Eu, Dy | 50 | 50 |
| 82 | Zn_{0.65}Mg_{0.35}S: Ag, Cl | Non-persistent | ZnS: Ag, Cl | 50 | 50 |
| 83 | Zn_{0.65}Mg_{0.35}S: Ag, Cl | Persistent | ZnS: Cu, Cl | 50 | 50 |
| 84 | Zn_{0.65}Mg_{0.35}S: Ag, Cl | Persistent | SrAl₂O₄: Eu, Dy | 78 | 22 |
| 85 | Zn_{0.65}Mg_{0.35}S: Ag, Cl | Persistent | SrAl₂O₄: Eu, Dy | 70 | 30 |
| 86 | Zn_{0.65}Mg_{0.35}S: Ag, Cl | Persistent | SrAl₂O₄: Eu, Dy | 32 | 68 |
| 87 | Zn_{0.65}Mg_{0.35}S: Ag, Cl | Persistent | SrAl₂O₄: Eu, Dy | 20 | 80 |
| 88 | Zn_{0.65}Mg_{0.35}S: Ag, Cl | Persistent | CaAl₂O₄: Eu, Nd | 50 | 50 |
| 89 | Zn_{0.65}Mg_{0.35}S: Ag, Cl | Persistent | BaAl₂O₄: Eu, Lu | 50 | 50 |

| | EL | | | | | EL | Time (hr) |
|---|---|---|---|---|---|---|---|
| | emission | PL | | EL | EL | energizing | until |
| | wavelength | wavelength | EL Voltage | frequency | energizing | brightness | reaching |
| | (nm) of (1) | (nm) of (2) | (V) | (Hz) | time (min) | (cd/m²) | 0.3 mcd/m² |
| 77 | 516 | 520 | 200 | 800 | 10 | 38 | 0.0005 |
| 78 | 455 | 520 | 200 | 800 | 10 | 46 | 0.8 |
| 79 | 399 | 520 | 200 | 800 | 10 | 23 | 8 |
| 80 | 422 | 520 | 200 | 800 | 10 | 31 | 9.3 |
| 81 | 369 | 520 | 200 | 800 | 10 | 38 | 12 |
| 82 | 369 | 450 | 200 | 800 | 10 | 48 | 0.0006 |
| 83 | 369 | 522 | 200 | 800 | 10 | 44 | 5.4 |
| 84 | 369 | 520 | 200 | 800 | 10 | 16 | 12 |
| 85 | 369 | 520 | 200 | 800 | 10 | 20 | 9.2 |
| 86 | 369 | 520 | 200 | 800 | 10 | 26 | 7.7 |
| 87 | 369 | 520 | 200 | 800 | 10 | 22 | 3 |
| 88 | 369 | 442 | 200 | 800 | 10 | 25 | 8.3 |
| 89 | 369 | 500 | 200 | 800 | 10 | 33 | 11.3 |

In TABLE 26, the emission wavelength refers to the peak wavelength on the long-wavelength side of the resulting spectrum.

The second phosphor did not persist because the light energy was low when the EL emission wavelength of the first phosphor was 516 nm. This is thought to be due to insufficient energy to excite the second phosphor.

The persistence period was extended as the EL emission wavelength of the first phosphor was reduced. When the brightness during EL energizing and the persistence period are considered, the first phosphor is preferably 30 to 70% of the entire phosphor. The persistence period was extended as the PL emission wavelength of the first phosphor was increased.

When a non-persistent phosphor was used as the second phosphor, emissions did not persist, but the brightness during energizing was high. This is believed to be due to the fact that the second phosphor received the UV rays emitted from the first phosphor, and the brightness during light emission was higher than in a persistent phosphor.

### INDUSTRIAL APPLICABILITY

The phosphor of the present invention can emit UV rays in the emission wavelength range of 400 nm or less based on inorganic electroluminescence. EL sheets that use this phosphor form a thin, compact UV surface emission source, and gases and liquids that contain toxic substances, bacteria, and the like can therefore be cleaned by combining the sheet with a photocatalyst. NOx, SOx, CO gas, diesel particulates, pollen, duct, ticks, and the like can be decomposed and removed. Organic compounds contained in sewage water can be decomposed and removed. Possible applications also include sterilizing light sources for eliminating common bacteria, viruses, and the like. Toxic gases produced by chemical plants can be decomposed, and foul-smelling components can also be decomposed.

When a plurality of through-holes having suitable sizes are formed in EL sheets using the phosphor of the present invention, the configuration forms a filter having a UV-emitting function that allows fluids to pass through the sheet interior, and an excellent polluted-fluid cleaning device can be formed when used in combination with a photocatalyst. Since fluids can flow through the interior of the EL sheet when through-holes are formed in the EL sheet and a photocatalyst sheet is laminated, the contact efficiency of the fluid and photocatalyst is increased, a photocatalyst with enhanced performance can be obtained, and the EL sheet can be cooled by the passing fluids.

The ZnS-Group 2A sulfide phosphor of the present invention emits light in a wavelength region of 355 to 387 nm, which are UV rays required for exciting a photocatalyst and for use in insect traps, UV exposure, resin curing, and various other applications. Since it is possible to obtain emissions in the vicinity of 365 nm, which is a wavelength having broad applicability, PL, CL, and EL emission elements that use the phosphor of the present invention can be expected to be used as light sources in such applications.

When Ag and Au are used as activators, the phosphor surface can be prevented from becoming charged when a phosphor in which Au particles precipitate to the phosphor surface is used in an electron beam-excited fluorescent lamp, and a fluorescent lamp excited with a low-speed electron beam in particular. Stable emissions can therefore be obtained. Light in which the emission peak wavelength is 420 nm or less can be emitted using inorganic EL.

The ZnS-based phosphor of the present invention can emit short-wavelength light having a peak wavelength of 420 nm or less by using interstitial Ag doping. By simultaneously doping Au, efficient EL emissions are made possible because Au is present along grain boundaries. A light-emitting device fabricated using the present phosphor can efficiently excite rutile TiO₂ and anatase TiO₂ photocatalysts. The present phosphor can emit short-wavelength light with good efficiency when used as a phosphor for a fluorescent lamp excited with a low-speed electron beam because the phosphor contains highly electroconductive Au.

The fluorescent lamp of the present invention comprises a light-emission container in which a phosphor layer is formed on the inner surface and the interior has been evacuated, a cathode as the electron emitter inside the light-emission container, and a phosphor layer that is formed in the vicinity of the anode and has a function for emitting UV rays by CL.

The use of a field-emission cold cathode is preferred over a hot cathode. A field-emission cold cathode generally has an electron emitter that is formed on the cathode, and a gate electrode that surrounds the electron emitter. When a cold cathode provided with carbon nanotubes or another electron gun as the electron emitter is used, the voltage required for electron emission is low, power can be saved, and sufficiently high brightness can be assured for an UV emission source because of the large quantity of emitted electrons. Since a field-emission cold cathode is used, a heat source is no longer required, handling is facilitated, manufacture is simplified, response speed is improved, power consumption can be reduced, and the longevity of the fluorescent lamp can be greatly extended.

The fluorescent lamp of the present invention can emit UV rays having a wavelength of less than 400 nm, and is a light source that can very efficiently sterilize bacteria, viruses, and the like. Using a combination with a photocatalyst makes it possible to decompose and remove organic material, bacteria, and viruses; atmospheric pollutants such as NOx, SOx, CO gas, and diesel particulates; and pollen, dust, ticks, and the like. Organic compounds contained in sewage water can be decomposed and removed. Possible applications also include sterilizing light sources for eliminating common bacteria, viruses, and the like. Toxic gases produced by chemical plants can be decomposed, as can foul-smelling components. In particular, UV rays having an emission peak wavelength in the range of 360 to 375 nm are effective for UV-curing resin systems, and since these wavelengths are preferred by insects, the fluorescent lamp can also be effectively used as an insect-trapping lamp.

The surface-emitting device of the present invention has a surface emitter that is a combination of a phosphor (first phosphor) that can emit UV rays or visible light by EL, and a phosphor (second phosphor) that emits visible light by using emitted visible light or UV rays. By using a persistent phosphor as the second phosphor, the device has a characteristic in which light is emitted by EL when an electric field is applied, and continues to be emitted as persistent light when the electric field has been turned off. When the surface-emitting device of the present invention is used as the backlight of a mobile phone or clock, the backlight is lighted and the screen is displayed when the user operates the apparatus, and the backlight continues to be lighted even when the user has ceased operating the apparatus and the power source has been switched off. Therefore, power consumption is low, and the backlight can be viewed even in dark locations. In the particular case that the device is used as the backlight of a second screen (the screen disposed on the exterior when the mobile phone is folded) of a foldable mobile phone, the time and mail arrival information can be easily viewed, resulting in a favorable configuration. Application can also be made to an emergency display board or the like.

A surface-emitting device can be obtained that can emit visible light with good color purity by using a phosphor that is caused to emit visible having good color purity by irradiation with UV rays.

1. A phosphor characterized in having a function to emit blue-Cu light and in being expressed by the general formula Zn₍₁₋ₓ₎AₓS:E, D, wherein A is at least one type of Group 2A element selected from the group consisting of Be, Mg, Ca, Sr, and Ba; E is an activator comprising Cu or Ag; D is a co-activator comprising at least one element selected from a Group 3B element and a Group 7B element; and x is a mixed crystal ratio that satisfies the expression 0≦x<1.

2. The phosphor according to claim 1, characterized in comprising the activator E in a molar concentration that is equal to or greater than the molar concentration of the co-activator D.

3. The phosphor according to claim 2, characterized in that the concentration of the activator E is 0.006 to 6 mol % with respect to the sum of Zn and A in the general formula.

4. The phosphor according to claim 3, characterized in that the concentration of the activator E is 0.01 to 1 mol % with respect to the sum of Zn and A in the general formula.

5. The phosphor according to claim 2, characterized in that the concentration of the activator D is 0.1 to 90 mol % of the concentration of the activator E.

6. The phosphor according to claim 5, characterized in that the concentration of the activator D is 0.1 to 60 mol % of the concentration of the activator E.

7. The phosphor according to claim 1, characterized in that the activator E in the general formula is Cu, x is 0<x<1, and the wavelength of a part of the electroluminescent emission spectrum measured by applying an AC electric field is in a region that is 400 nm or less.

8. The phosphor according to claim 7, characterized in that the integral emission intensity of the region in which the wavelength of the EL emission spectrum is 420 nm or less is 25% or more of the entire emission intensity.

9. The phosphor according to claim 7, characterized in that the integral emission intensity of the region in which the wavelength of the EL emission spectrum is 400 nm or less is 5% or more of the entire emission intensity.

10. The phosphor according to claim 1, characterized in that the activator E in the general formula is Ag, and x is 0<x<1.

11. The phosphor according to claim 10, characterized in that two types of emission peaks having different wavelengths are present.

12. The phosphor according to claim 11, characterized in that the emission peak intensity on the short-wavelength side of the two types of emission peaks is 20% or more of the emission peak intensity on the long-wavelength side.

13. The phosphor according to claim 10, characterized in that the emission peak wavelength on the short-wavelength side is 387 nm or less.

14. The phosphor according to claim 13, characterized in that the emission peak wavelength on the short-wavelength side is 355 to 387 nm.

15. The phosphor according to claim 10, characterized in that the α crystal phase is 50% or more of the total crystal phase.

16. The phosphor according to claim 15, characterized in that the α crystal phase is 80% or more of the total crystal phase.

17. The phosphor according to claim 1, characterized in that the activator E in the general formula is Ag and Au, x is 0≦x<1, and electroluminescent light is emitted.

18. The phosphor according to claim 17, characterized in that the sum of the molar concentrations of the activators Ag and Au is 0.01 to 1 mol % with respect to the sum of Zn and A in the general formula.

19. The phosphor according to claim 17, characterized in that the concentration of the co-activator D is 0.1 to 80 mol % with respect to the sum of the molar concentrations of the activators Ag and Au.

20. The phosphor according to claim 17, characterized in that x is 0≦x≦0.5.

21. The phosphor according to claim 17, characterized in that the molar concentration of the Ag activator is greater than the sum of the molar concentrations of the co-activator D.

22. The phosphor according to claim 21, characterized in that the concentration of the co-activator D is 0.05 to 80 mol % of the molar concentration of the Ag activator.

23. The phosphor according to claim 17, characterized in that the molar concentration of the Ag activator is 0.01 to 0.5 mol % with respect to the sum of Zn and A in the general formula.

24. The phosphor according to claim 17, characterized in that the emission spectrum measured by photoluminescence, cathode luminescence, or electroluminescence has one or more peaks, and the peak wavelength of at least one peak is 420 nm or less.

25. The phosphor according to claim 24, characterized in that the peak wavelength of at least the one peak is 400 nm or less.

26. The phosphor according to claim 24, characterized in that the peak intensity on the shortest-wavelength side of the emission spectrum is greater than other peak intensities.

27. A fluorescent lamp in which the phosphor according to claim 10 is used and which is characterized in comprising a hot cathode or an field-emission cold cathode, an anode, and a phosphor layer formed on the anode, wherein the phosphor has a function for emitting UV rays having a wavelength of less than 400 nm by using cathode luminescence, and x in the general formula satisfies the expression 0<x≦0.5.

28. The fluorescent lamp according to claim 27, characterized in that an electrically conductive powder is added to, or is coated onto, the phosphor layer.

29. The fluorescent lamp according to claim 27, characterized in that an electrically conductive powder is combined inside the phosphor layer.

30. The fluorescent lamp according to claim 28 or 29, characterized in that an electrically conductive powder is a Cu—S-based compound.

31. The fluorescent lamp according to claim 27, characterized in that an electron emitter of the field-emission cold cathode is oriented vertically with respect to the cathode surface.

32. The fluorescent lamp according to claim 27, characterized in that a second phosphor for emitting visible light by UV irradiation is further added to the phosphor.

33. A field-emission display, characterized in using the fluorescent lamp according to claim 27, and in that a phosphor layer having a function for emitting visible light by UV irradiation is formed on the exterior of the light-emission container.

34. A method for manufacturing the phosphor according to claim 1, characterized in comprising:
a step for mixing an activator, a co-activator, and a phosphor matrix that comprises Zn and A in the general formula;
a drying step;
a baking step; and
a cooling step.

35. The method for manufacturing a phosphor according to claim 34, characterized in that the cooling rate in the cooling step is 1° C./min to 100° C./min.

36. The method for manufacturing a phosphor according to claim 34, characterized in further including an annealing treatment step performed at a low temperature that is equal to or less than the baking temperature during the cooling step or after the cooling step.

37. The method for manufacturing a phosphor according to claim 36, characterized in that strain is introduced inside the phosphor prior to the annealing treatment step.

38. The method for manufacturing a phosphor according to claim 34, characterized in that the mixing step is carried out in a nonaqueous solvent or in a nonoxidizing gas.

39. A surface-emitting device characterized by having a phosphor that emits light by inorganic electroluminescence and is a compound material composed a first phosphor having a function whereby UV rays or visible light having a peak wavelength of 460 nm or less is emitted by applying an AC electric field, and a second phosphor that is caused to emit visible light by irradiation with visible light or UV irradiation.

40. A surface-emitting device that uses the phosphor according to claim 1, characterized in having a surface emitter that is a combination of a first phosphor and a second phosphor, wherein
the first phosphor is the phosphor according to claim 1 that emits light by inorganic electroluminescence and has a function whereby UV rays or visible light having a wavelength 460 nm or less is emitted by the application of an AC electric field; and wherein
the second phosphor is caused to emit visible light by irradiation with visible light rays or UV rays.

41. The surface-emitting device according to claim 39 or 40, characterized in that the first phosphor is a phosphor having a function for emitting UV rays that have an emission peak wavelength of less than 400 nm.

42. The surface-emitting device according to claim 41, characterized in that the first phosphor is a phosphor having a function for emitting UV rays that have an emission peak wavelength in a range of 300 to 375 nm.

43. The surface-emitting device according to claim 39 or 40, characterized in that the second phosphor is a persistent phosphor.

44. The surface-emitting device according to claim 43, characterized in that the persistent phosphor is an oxide-based phosphor.

45. The surface-emitting device according to claim 39 or 40, characterized in that the second phosphor is a phosphor in which a compound expressed by MAI₂O₄ is used as the base crystal, Eu is added as an activator, and at least one or more elements selected from the group consisting of Ce, Pr, Nd, Sm, Tb, Dy, Ho, Er, Tm, Yb, and Lu are furthermore added as a co-activator, wherein M is at least one metal element selected from the group consisting of Ca, Sr, and Ba.

46. A persistent backlight that uses the surface-emitting device according to claim 39 or 40.

47. The persistent backlight according to claim 46, used as a screen of a mobile phone.
